(19) United States
(12) Patent Application Publication
(10) Pub. No.: US 2017/0013849 A1
(43) Pub. Date: Jan. 19, 2017

(54) APPARATUS AND METHOD FOR SPRAYING FOOD AND FOOD PROCESSING ARTICLES WITH ANTIMICROBIALS AND OTHER AGENTS

(71) Applicant: TUSARA SOLUTIONS, LLC, Lincoln, NE (US)

(72) Inventors: Harshavardhan Thippareddi, Lincoln, NE (US); Jeyamkondan Subbiah, Lincoln, NE (US)

(21) Appl. No.: 15/211,612

(22) Filed: Jul. 15, 2016

Related U.S. Application Data
(60) Provisional application No. 62/192,705, filed on Jul. 15, 2015.

(51) Int. Cl. A23B 4/30; A23B 5/20; B05D 1/02; A23B 7/158; A23B 7/153; A23B 4/18; A23B 5/12

(52) U.S. Cl. CPC A23B 4/30; A23B 4/18; A23B 5/20; A23B 5/12; A23B 7/158; A23B 7/153; B05D 1/02; A23V 2002/00

(57) ABSTRACT

Provided herein are methods, apparatuses, and systems for treating food articles, including meat, poultry, fish and other seafood, vegetables, fruits and other foods and food processing articles by spraying an antimicrobial or other agent onto the food or food processing articles. One embodiment of the invention may include a method for treating a food article comprising disposing a food article in a cavity within an enclosure having an outer shell and at least one inner plate disposed in the cavity, applying a first charge to a antimicrobial agent, applying a second charge to the at least one inner plate of the same polarity as the first charge, and spraying the antimicrobial agent into the cavity in a manner whereby at least a portion of the antimicrobial agent is caused to be repelled by the at least one inner plate and to at least partially coat the food article.

### CROSS REFERENCE TO RELATED APPLICATIONS

This application claims priority to U.S. Provisional Patent Application No. 62/192,705, filed Jul. 15, 2015, entitled “APPARATUS AND METHOD FOR ELECTROSTATIC SPRAYING OF ANTIMICROBIALS AND OTHER TREATMENT AGENTS,” the contents of which are hereby incorporated by reference in its entirety.

### FIELD OF THE INVENTION

The present invention relates to methods and apparatuses for spraying food articles and food processing articles with antimicrobials and other treatment agents.

### BACKGROUND OF THE INVENTION

During post-harvest processing or other processing of raw meat (which as used herein includes poultry), ready-to-eat (“RTE”) meat, fish and other seafood, vegetables and fruits or other food products, such food products and food processing equipment may be contaminated with foodborne pathogens and other spoilage microorganisms. In the case of raw meat, for example, conversion of meat animals to meat may result in contamination of the carcasses with microorganisms originating from the carcass surface, the intestinal content, and/or the processing environment including articles therein. Meat processors typically take some procedural care in minimizing this contamination and may apply antimicrobials as a dip or a spray to reduce the microbial load. Traditional spraying of antimicrobial solutions onto carcasses may not be very effective as the antimicrobials do not cover the entire surface of the carcass, especially on crevices. In many situations, even missing 1% of the surface of an animal carcass may contaminate the processed meat and may pose food safety, shelf life and quality issues.

This is especially true for poultry carcasses that have feather follicles (pores) resulting from de-feathering, which can hide the organisms inside the skin, thus protected from the antimicrobial being applied on the surface. Poultry processors may dip carcasses in antimicrobial solutions, especially during chilling or post-chill application of antimicrobials to achieve uniform coverage resulting in microbial reductions. Dipping of the food products (e.g. whole poultry carcasses, meat parts, fish, vegetables, etc.) in the antimicrobials may be effective at controlling microbial load; however, disadvantages of dipping may include large use and wastage of antimicrobial solutions, the product picking up moisture and developing off-odors, and the antimicrobial solution may cause discoloration. Current methods typically apply antimicrobials at low concentrations for product quality concerns (e.g. discoloration, odors, etc.) and safety concerns in a food processing plants. Current spray methods additional have the disadvantage of instances of non-uniform distribution of antimicrobial agent such as in crevices, and shadow regions of carcasses. Similar problems arise in the application of antimicrobial agents to other food articles other than poultry, such as RTE meats (including deli meats sliced during processing or intended for slicing thereafter), raw meat parts, fish and other seafood, vegetables and fruits, and other food products whose safety may be increased via application of antimicrobial agents. Hence there is a need to apply treatment agents, including but not limited to antimicrobial agents, in a way to improve their application, uniform distribution of antimicrobial on the food articles, and/or use of higher concentrations of antimicrobial agents while minimizing the waste of treatment agents and water pick up by the food articles.

Existing spraying systems may ineffectively apply the antimicrobial agent to the food articles being treated, either by missing portions of the article or spraying the structure of the surrounding or enclosing cabinet rather than the articles being treated. Moreover, uneven surfaces on the food articles may cause further losses in coverage and efficiency. Still further, in some instances, an antimicrobial agent may be released outside of the spraying system and may pose a health hazard for nearby workers.

Applicant has identified these and a number of additional deficiencies and problems associated with conventional spray coating systems and antimicrobial treatment systems. Through applied effort, ingenuity, and innovation, many of these identified problems have been solved by developing solutions to these problems that are included in embodiments of the present invention, many examples of which are described in detail herein.

### BRIEF SUMMARY OF THE INVENTION

As detailed herein, methods of treating food articles and food processing articles with treatment agents, methods of manufacturing treatment systems, and apparatuses for treating food articles and food processing articles with treatment agents are provided. Methods for treating food and food processing articles with treatment agents may use one or more elements of the electrostatic treatment apparatuses described herein or combinations of elements thereof.

In certain embodiments, an apparatus constructed in accordance with the present invention may include a cabinet comprising an outer shell, the outer shell may define a cavity in an interior thereof. Cabinet as used herein includes but is not limited to any housing, partial housing, enclosure, partial enclosure, chamber, cylinder, channel, tunnel or combinations of one or more thereof such as for example, two cylinders that are mitered and joined at an angle, or a partial enclosure joined with one or more cylinders. The cabinet and its outer shell may be of various shapes and configurations with openings in various locations, including but not limited to the shape of a cylinder (pipe like), half cylinder (tunnel like), and channel. In the embodiment, the apparatus may include a spray assembly disposed within the cabinet. The cabinet and its outer shell may be separated from interior components by insulators and spacing. The spray assembly may include at least one nozzle. At least one inner plate may be disposed within the cavity of the outer shell, and the at least one inner plate may be electrically isolated from the outer shell or be formed integrally with or comprise a portion of the outer shell. Inner plate as used herein include but is not limited to any inner housing, inner partial housing, inner enclosure, inner partial enclosure, inner chamber, inner cylinder, inner channel, or inner housing or enclosure that is a combination of one or more thereof, such as for example, a series of inner plates that are interconnected, a series of inner plates that are not connected, two inner cylinders that are mitered and joined at an angle, or a partial inner enclosure joined with one or more inner cylinders. The at least one inner plate may be comprised of conductive material. The at least one inner plate may be of various shapes and configurations with openings in various locations, for example, in some embodiments, the inner plate may be similar in shape to the outer shell with openings to accommodate the spray nozzle and other devices to apply a charge to an food article disposed in the cavity of the outer shell. In some embodiments, the shape of the inner plate may include but is not limited to the shape of any housing, enclosure, partial enclosure, chamber, cylinder, channel, or combinations of one or more thereof such as for example, two cylinders that are mitered and joined at angle. In some embodiments, the one or more inner plates may form one or more cavities or chambers for treating a food article with a treatment agent.

In some embodiments, the apparatus may further include at least one charged body integrated in, attached to, or otherwise disposed within the cabinet and disposed at least partially within the cavity of the outer shell. Some embodiments may incorporate charged bodies of one or more shapes and configurations. For example, the charged bodies may be rods, pins, brushes, flanges, rod or brushes including multiple bristles or pins, wires and may be configured to telescope, retract, or position at an angle.

In some embodiments, the apparatus may further include at least one capture section integrated within the cabinet or attached to at least one side of the cabinet. The at least one capture section may have an outer shell that defines a cavity. The one capture section may include at least one second inner plate disposed within the cavity of the capture section, and the at least one second inner plate may be electrically isolated from the outer shell of the capture section. In another embodiment where the capture section is integrated within the cabinet, the cavity of the capture section may be defined by the outer shell of the cabinet, and the at least one second inner plate disposed within the cavity in a manner that may be electrically isolated from the outer shell of the cabinet. In an alternative embodiment where the capture section is integrated within the cabinet, the at least one second inner plate disposed within the cavity in a manner that is not electrically isolated from the outer shell of the cabinet and the outer shell is coated with an insulating material. The at least one second inner plate may be of various shapes and configurations with openings in various locations. In one embodiment the at least one second inner plate can have a funnel shape adapted to direct the flow of sprayed treatment agent into a funnel for collection. In another embodiment the at least one second inner plate can have the form of a mesh screen. In yet another embodiment the at least one second inner plate may be adapted to move in a centrifugal direction.

In some embodiments, the at least one capture section may include at least a first capture section integrated with or attached to a first side of the cabinet and a second capture section integrated with or attached to a second side of the cabinet. The first side may be upstream of the cabinet in a treatment process and the second side may be downstream of the cabinet in the treatment process. In some embodiments, the capture section may include separators for separating the treatment agent in a liquid mist or atomized liquid form from the air.

In some embodiments, the cabinet may be modular for the treatment of stationary articles. In such embodiments, the cabinet and its outer shell and inner plate can be configure in the shape of a dome with a spray nozzles disposed therein, such that the stationary product on a flat surface may be covered by the modular dome shaped cabinet and sprayed with a treatment agent. One or more of the features of the embodiments disclosed herein may be incorporated in this embodiment.

In other embodiments, a cabinet with opening for placing a stationary article inside the cabinet may be configured one or more of the features of the embodiments disclosed herein. For example, a salad may be placed in a cabinet to be treated with a treatment agent prior to consumption by a person. The cabinet may include charging bodies for applying a charge to a stationary article.

In one embodiment of a method in accordance with the present invention, the method may include disposing a food article in the cavity of the outer shell. A first charge may be applied to a treatment agent. The method may include applying the second charge, having the same polarity as the first charge, to the at least one inner plate, and may include spraying the treatment agent onto the food article within the cavity, such that the treatment agent may be configured to adhere to the food article and may be configured to be repelled by the at least one inner plate.

Adhere as used herein shall mean fully or partially adhere, contact, cover, coat, glaze, dust, and/or otherwise fully or partially come into physical contact with an article. Use of one or more of the foregoing terms to describe a treatment agent coming into contact with an article is not intended to limit any embodiment, and as will be readily apparent to one of ordinary skill in the art, use of one of the foregoing terms may be interpreted to mean all of the foregoing terms.

Embodiments of the method may include repelling or reflecting at least a portion of the treatment agent towards the food article with the at least one inner plate. In some embodiments, more than one inner plate will have more than one charge of the same polarity with different degrees in order to focus a higher amount of treatment agent on a desired part of a food article being treated. For example, one inner plate may be charged at +2 kV and another inner plate charged at +4 kV.

Embodiments of the method may further include contacting the article to the charged body to apply a third charge to the food article, wherein the first charge applied to a treatment agent has an opposite polarity from the third charge applied to the food article.

In some embodiments of the method, disposing the food article in the cavity of the outer shell may include transporting the food article into and out of the shell via a conveyor system. Additionally or alternatively, disposing the food article in the cavity of the outer shell may include positioning the food article in a stationary location within the outer shell.

In some embodiments, the method may also include applying a fourth charge, having an opposite polarity from the first charge applied to the treatment agent, to at least one second inner plate disposed within the at least one capture section; and collecting excess treatment agent from the cabinet via at least one capture section integrated with or attached to at least one side of the cabinet.

In some other embodiments of the present invention, a method of manufacturing a food article treatment apparatus may be provided. The method of manufacture may include providing a cabinet comprising an outer shell, the outer shell defining a cavity in an interior thereof. Embodiments of the method may include disposing a spray assembly within the cabinet, the spray assembly including at least one nozzle configured to deliver a treatment agent having a first charge within the cavity of the cabinet. The method may further include connecting at least one inner plate within the cavity of the outer shell, such that the at least one inner plate may be electrically isolated from the outer shell. The at least one inner plate may be configured to be charged with the second charge of the same polarity as the first charge, such that the at least one inner plate may be configured to repel the treatment agent having the first charge.

Embodiments of the method of manufacturing a food article treatment apparatus may include connecting a charged rod within the cabinet such that the charged rod may be disposed at least partially within the cavity of the outer shell. The charged rod may be configured to be charged with a third charge. The third charge may have an opposite polarity from the first charge, such that the charged rod may be configured to apply the third charge to a food article.

The method of manufacturing a food article treatment apparatus may further include attaching at least one capture section to at least one side of the cabinet. The at least one capture section may include at least one second inner plate configured to receive a fourth charge having an opposite polarity to first charge.

In some embodiments of the method of manufacturing an food article treatment apparatus, the at least one capture section may include at least a first capture section integrated with, or attached to a first side of the cabinet and a second capture section integrated with or attached to a second side of the cabinet. The first side may be upstream of the cabinet in a treatment process and the second side may be downstream of the cabinet in the treatment process.

Embodiments of the method of manufacturing a food article treatment apparatus may further include attaching a collector beneath the outer shell of the cabinet, the collector configured to collect excess treatment agent.

In yet another embodiment of the present invention, an apparatus for treating food articles with treatment agents may include a cabinet comprising an outer shell defining a cavity in an interior thereof. The cabinet and its outer shell may be of various shapes and configurations with openings in various locations. The apparatus may further include a spray assembly (e.g., having one or more spray nozzles) disposed within the cabinet, the spray assembly including at least one nozzle configured to deliver a treatment agent having a first charge within the cavity of the cabinet. In some embodiments at least one inner plate may be disposed within the cavity of the outer shell. The at least one inner plate may be electrically isolated from the outer shell. The at least one inner plate may be configured to be charged with a second charge of the same polarity as the first charge, such that the at least one inner plate may be configured to repel the treatment agent having the first charge.

In some embodiments, the at least one inner plate may be of various shapes and configurations with openings in various locations. For example, in some embodiments, the at least one inner plate may include at least two inner plates defining a treatment chamber there between, and may define an outer cavity between at least one of the at least two plates and the outer shell of the cabinet. In other embodiments, the at least one inner plate may include an inner shell similar to the interior shape of the outer shell of the cabinet defining a treatment chamber between the inner walls of the inner shell, and an outer cavity between the outer walls of the inner shell and the inner walls of the outer shell.

The apparatus may further include a charged rod attached within the cabinet and disposed at least partially within the cavity of the outer shell, and more particularly in embodiments having a treatment chamber form by one or more inner plates, the charged rod would be at least partially disposed in the treatment chamber. The charged rod may be configured to be charged with a third charge. The third charge may have an opposite polarity from the first and second charges, such that the charged rod may be configured to apply the third charge to a food article.

In any of the embodiments described herein, at least one capture section may be attached to at least one side of the cabinet, wherein the at least one capture section may include at least one second inner plate configured to receive a fourth charge. The at least one capture section may include at least a first capture section integrated with or attached to a first side of the cabinet and a second capture section integrated with or attached to a second side of the cabinet. The first side may be disposed upstream of the cabinet in a treatment process (i.e., food articles leaving this capture section pass into the cabinet where the treatment agent is sprayed) and the second side may be disposed downstream of the cabinet in the treatment process (i.e., food articles leaving part of the cabinet where the treatment agent is sprayed pass into this capture section).

A collector may be integrated within or attached to the outer shell of the cabinet, the collector configured to collect excess treatment agent. The collector may include one or more pumps or siphoning devices. The collector may include one or more channels, drains, trays, tanks, or the like for receiving and transporting the excess treatment agent from the cabinet.

In some embodiments, the apparatus may include an insulating member disposed between the outer shell and the at least one inner plate. The insulating member may be configured to electrically isolate the at least one inner plate from the outer shell. The outer shell may include one or more wall segments. Alternatively, the outer shell (or one or more portions of it) may be the at least one inner plate with or without an insulating coating or covering on the exterior surface. In another embodiment, the outer shell may be configured with insulating blocks mounted to the interior of the outer shell for mounting the at least one inner plate, the blocks may have insulated holes in the axial center of the block for charging wires for applying a charge to the at least one inner plate.

In some embodiments, the apparatus may include a conveyor connected to the cabinet for transporting an food article in the outer shell of the cabinet

### BRIEF DESCRIPTION OF THE DRAWINGS

Having thus described the invention in general terms, reference will now be made to the accompanying drawings, which are not necessarily drawn to scale, and wherein:

FIG. 1 shows a perspective view of a treatment system in accordance with some example embodiments described herein;

FIG. 2 shows a perspective view of a conveyor in accordance with some example embodiments described herein;

FIG. 3 shows a front plan view of a cabinet in accordance with some example embodiments described herein;

FIG. 4 shows a perspective view of a cabinet in accordance with some example embodiments described herein;

FIG. 5 shows a rear plan view of a cabinet in accordance with some example embodiments described herein;

FIG. 6 shows a perspective view of a cabinet in accordance with some example embodiments described herein;

FIG. 7 shows a perspective view of a partial cabinet in accordance with some example embodiments described herein;

FIG. 8 shows a cross section view of a cabinet configured in the shape of a half cylinder in accordance with some example embodiments described herein;

FIG. 9 shows a perspective view of a cabinet configured in the shape of a cylinder in accordance with some example embodiments described herein;

FIG. 10 shows a cross section view of a cabinet configured in the shape of a half cylinder in accordance with some example embodiments described herein;

FIG. 11 shows a lateral section view of the cabinet depicted in FIG. 10;

FIG. 12 shows a perspective view of a cabinet configured in the shape of two cylinders meeting at an angle to form an L-shape in accordance with some example embodiments described herein;

FIG. 13 shows a cross section view of an air separator that may be integrated with or attached to a capture section in accordance with some example embodiments described herein;

FIG. 14 shows a cross section view of an air separator that may be integrated with or attached to a capture section in accordance with some example embodiments described herein; and

FIG. 15 shows a cross section view of a cabinet configured in the shape of a half cylinder in accordance with some example embodiments described herein.

### DETAILED DESCRIPTION

Embodiments of the present invention now will be described more fully hereinafter with reference to the accompanying drawings, in which some, but not all embodiments of the invention are shown. Indeed, the invention may be embodied in many different forms and should not be construed as limited to the embodiments set forth herein.

Embodiments of the present invention include a treatment system for treating of food articles (or products) and food processing articles (processing equipment or components thereof) with electrostatic spray and apparatuses and methods associated therewith. Some embodiments of the present invention include apparatuses, systems, and methods for sanitizing food products and/or food processing equipment using electrostatically-applied treatment agents, including but not limited to antimicrobial agents, bacteriophages, other agents inhibiting the growth of microbials of other spoilage microorganisms, or other pathogen inhibitors. Food products may include raw and RTE meats, poultry, fish or other seafood, vegetables, fruits as well as other food products that undergo processing and may benefit from treatment agents to inhibit pathogens or other spoilage microorganisms.

Treatment apparatuses according to embodiments of the present invention may include a cabinet having a treatment area to receive food products, food processing equipment, or other articles for treatment therein. For example, antimicrobial agents may be charged and sprayed onto an oppositely charged, neutrally charged (e.g., grounded) or non-charged food product to allow the antimicrobial agent to adhere to and cover the food product. Some embodiments may include an inner plate comprised of conductive material within the cabinet that is charged with the same polarity as the antimicrobial agent or other treatment agent.

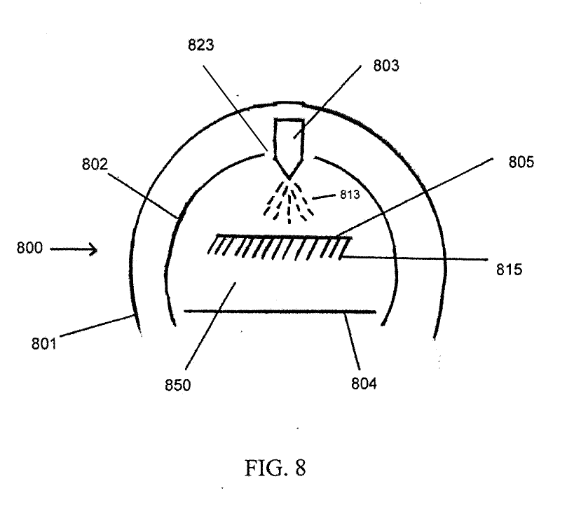

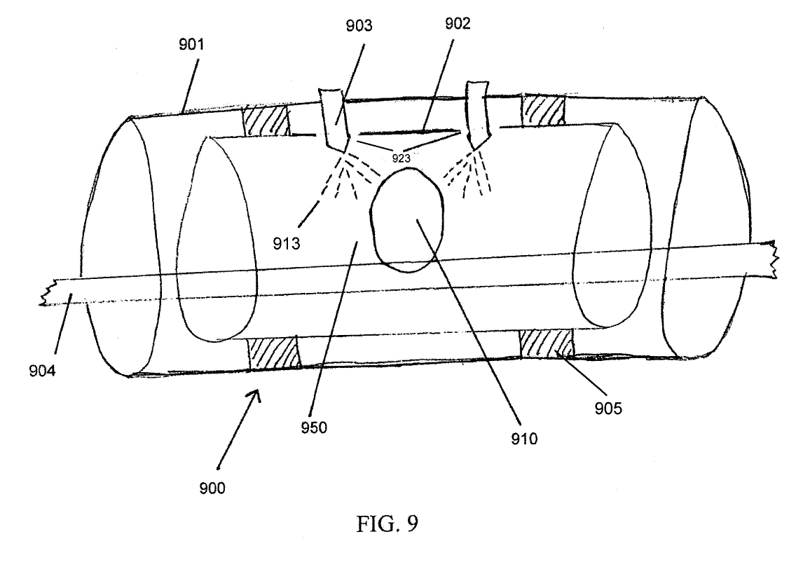

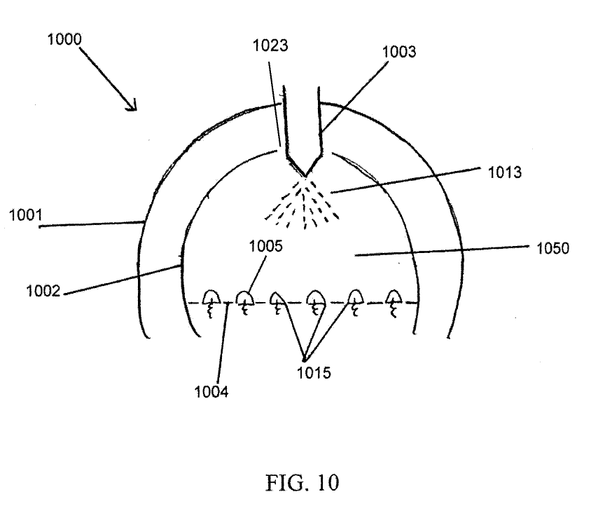

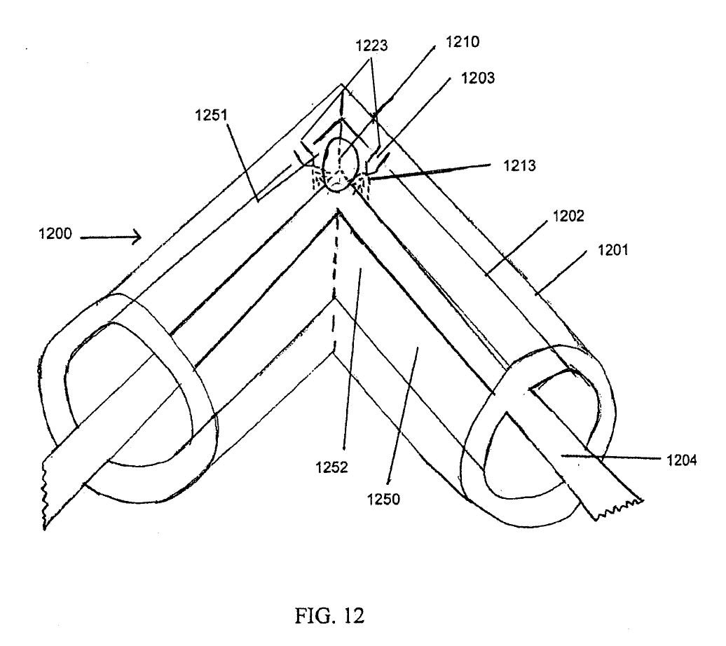

The inner plate may be electrically isolated from the walls of the cabinet. The inner plate may be hung or attached within the cabinet of the treatment device proximate the treatment area of the cabinet and may repel the antimicrobial agents towards the articles to focus the sprayed treatment agents onto the articles being treated and improve coverage while minimizing wasted treatment agent. In some embodiments, the inner plate may be of various shapes and configurations with openings in various locations. For example, in some embodiments, the inner plate may be a series of plates, or a plate shaped similar to the shape of the inner wall of the cabinet. For example, in an embodiment having a cabinet shaped as a cylinder as shown in FIGS. 9 and 12, the inner plate may be another cylinder, 902 and 1202, respectively, disposed within the cabinet. Similarly, in an embodiment having a cabinet shaped as a half cylinder as shown in FIGS. 8 and 10, the inner plate may be another half cylinder, 802 and 1002, respectively, disposed within the cabinet. In some embodiments the inner plate may be configured with one or more openings to accommodate spray nozzles and other charged bodies to apply a charge to an article disposed in the cavity of the outer shell and in some embodiments the article may be further disposed within a cavity formed by the inner plate.

Electric charges may be imparted onto one or both of the sprayed treatment agent and the articles being treated. A positive or negative electric charge may be imparted to an article or agent by removing or adding electrons respectively by applying a voltage to the article or agent. The charges in the article or agent may be created by applying a positive or negative voltage to the article or agent using a conductor or charged body (e.g., a conducting rod or charging rod) to add or remove electrons and create the positively or negatively charged article or agent. In some embodiments, a spray nozzle and/or charging rod may apply charges to the treatment agent and/or article respectively by applying a voltage of approximately 1-15 kV to the agent or article. In some embodiments, a charge-to-mass ratio above 5 mC/kg may be applied by the treatment agent and/or articles. In some further embodiments a charge-to-mass ratio of greater than 5.3 mC/kg, less than 16.7 mC/kg, or between 5.3 mC/kg and 16.7 mC/kg may be applied. In some embodiments, the charge applied to the treatment agent and articles may be considered additively. Higher charge-to-mass ratios may be used in the system to increase electrostatic deposition efficiency. While charge-to-mass ratios herein are represented as positive numbers, the charge may be either positive or negative, as explained herein.

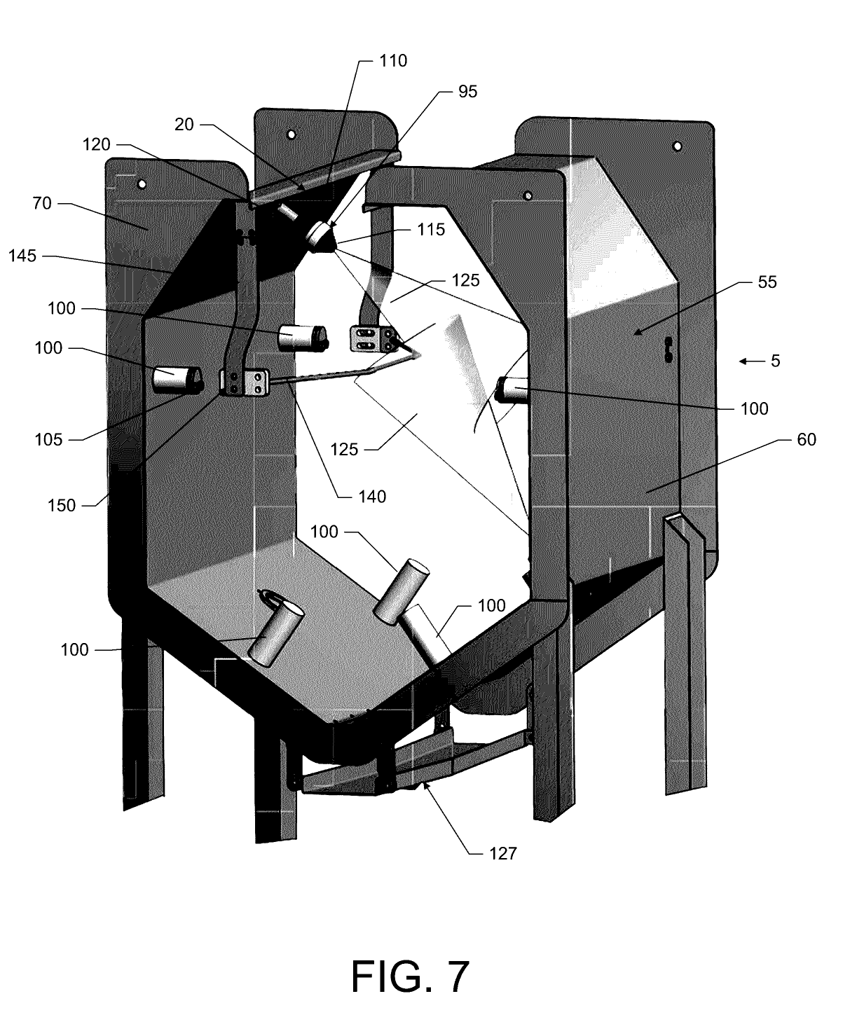

In some embodiments described above, electric charges may be imparted to the inner plate in addition to one or both of the sprayed treatment agent and the article being treated. A positive or negative electric charge may be imparted to the inner plate by applying a positive or negative voltage to the inner plate using a charging element electrically coupled to the inner plate (e.g., FIG. 7, 105) to add or remove electrons and create the positively or negatively charged article or agent. The inner plate charge may be the same polarity as the charge applied to the treatment agent in order to create a repelling effect. In some embodiments, the charging element may apply charges to one or more inner plates by applying a voltage of approximately 1-15 kV to the one ore more inner plates. The charge may be positive or negative. In some embodiments, the charge applied to the inner plate, the treatment agent and/or articles may be considered additively. For example, a voltage of −2 kV is applied to the treatment agent, and a voltage of −2 KV is applied to the inner plate, thereby making the potential difference 4 kV of repulsive force.

Embodiments of the present invention may be used to treat many types of products with many types of treatment agents. In some embodiments, animal meat carcasses may be treated using an antimicrobial agent during various stages of meat processing to decontaminate the meat prior to further processing and packaging. In some embodiments, poultry may be treated using an antimicrobial agent. The poultry may be treated during any stage of the meat processing process, such as, for example, after a defeathering process. In some embodiments, other raw and RTE meats, poultry, fish or other seafood, vegetables, fruits as well as other food products that undergo processing that may benefit from treatment agents to inhibit pathogens may be treated with one or more treatment agents. As will be readily appreciated by one of ordinary skill in the art, the treatment agents for use in accordance with embodiments of the present invention may include, but are not limited to, any pathogen inhibitor or inhibitor of other spoilage microorganisms, bacteriophage, antimicrobial agents, or other substances listed in the United States Department of Agriculture, Food Safety and Inspection Service, current or future version of FSIS Directive 7120.1, Safe and Suitable Ingredients Used in the Production of Meat, Poultry, and Egg Products (Rev. 35, last revised May 24, 2016). In some embodiments one or more of such substances may be used as the treatment agent, such as, e.g. peroxyacetic acid and acetic acid. In some alternative embodiments, food processing equipment or other reusable, sanitary equipment may be conveyed through the treatment system for decontamination with the treatment agents mentioned herein. Moreover, as will be readily appreciated by one of ordinary skill in the art, treatment agents may include coatings, glazes, marinades, seasoning, rubs, or other sprayable liquid, particle, powdered coatings, which may be applied to any number of articles using the systems, apparatus, and methods detailed herein. Additional sprayable liquid or particle coatings may include liquid smoke, smoke fractions, flavor fractions or other food additives.

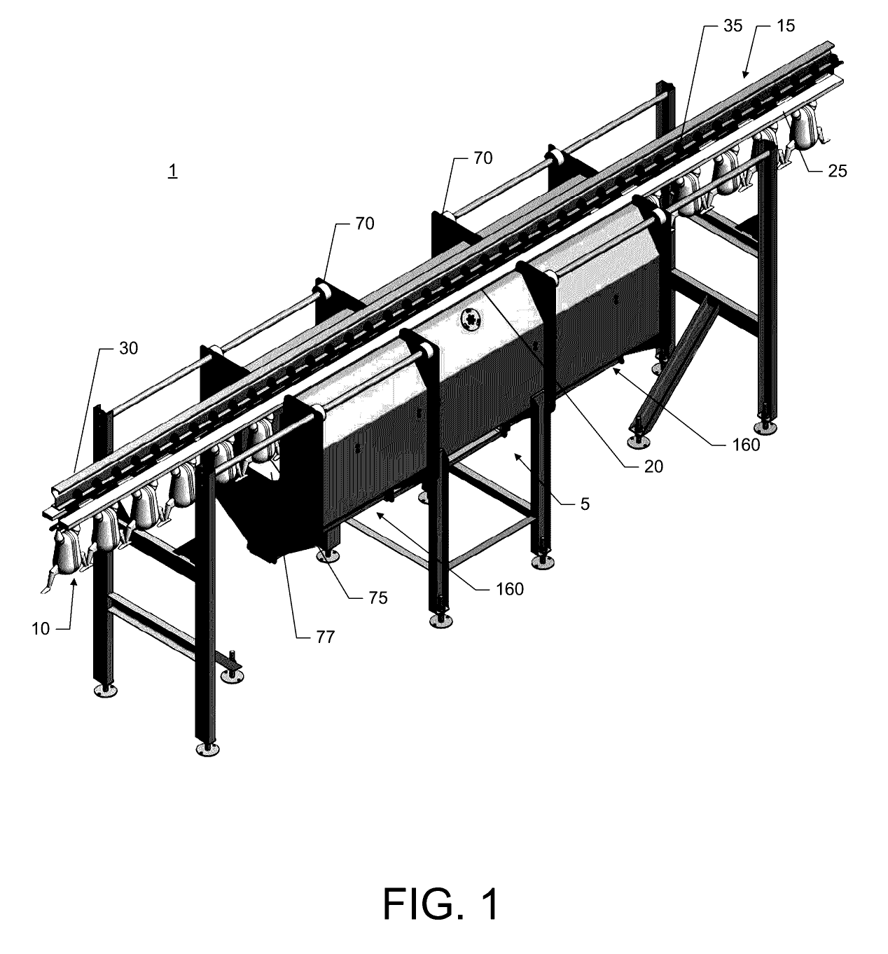

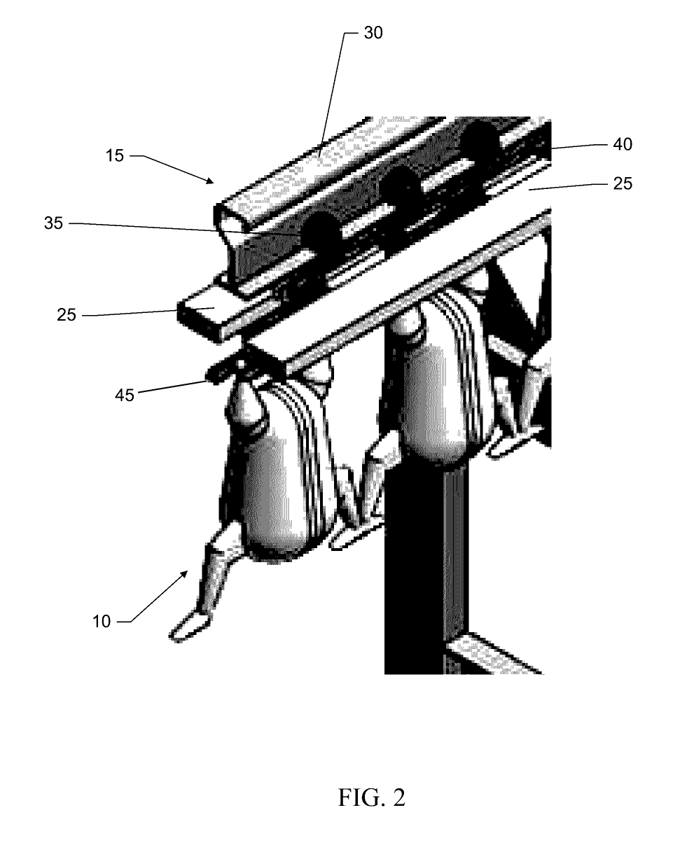

With reference to FIG. 1, a treatment system 1 is shown in accordance with some embodiments of the present invention. The treatment system 1 may include a treatment cabinet 5 that receives articles, such as food products (e.g., poultry 10) or equipment for treatment. A conveyor system 15 may be used to pass the food products or other articles through the treatment area 50 (shown in FIG. 2) of the treatment cabinet 5. Any suitable means for transporting and/or positioning the articles in the treatment chamber may be used, such as, for example, a hanging or flat conveyor belt, a cabling system, or non-moving mechanisms such as shelves or tanks. The conveyor acts as a transporting and/or positioning device that may place the articles into the treatment chamber via one or more openings (e.g., channel 20) in the treatment cabinet 5, or in some alternative embodiments, the articles may be sealed inside the cabinet via one or more sealable openings. In some embodiments, the cabinet may be made of metal, such as, for example, 316 stainless steel. At least a portion of the inner plates, outer shell, and/or the conveyor may include metal (e.g., 316 stainless steel). As will be readily appreciated by one of ordinary skill in the art, some embodiments may include portions of the cabinet, one or more inner plates, outer shell and/or conveyor being insulated or made with non-conductive material.

With reference to FIG. 2, an example conveyor 15 is shown. The conveyor 15 may include at least one rail 30 for supporting the articles (e.g., poultry 10) to be treated. The rails 30 may support pulley members 35 having clamps 45 or other engagement mechanisms for holding the articles. In some embodiments, the pulley members 35, clamps 45, and/or the entire conveyor assembly 15 may be insulated or made of nonconductive material to prevent charging the conveyor or surrounding components and to electrically isolate the poultry 10 or other articles being treated. In some embodiments, the pulley members 35 and/or clamps 45 may be electrified in order to apply a charge to the poultry 10 or other article, as detailed below. The conveyor 15 may include a chain, cable, or the like (e.g., the chain 40 shown in FIG. 2) for pulling the articles.

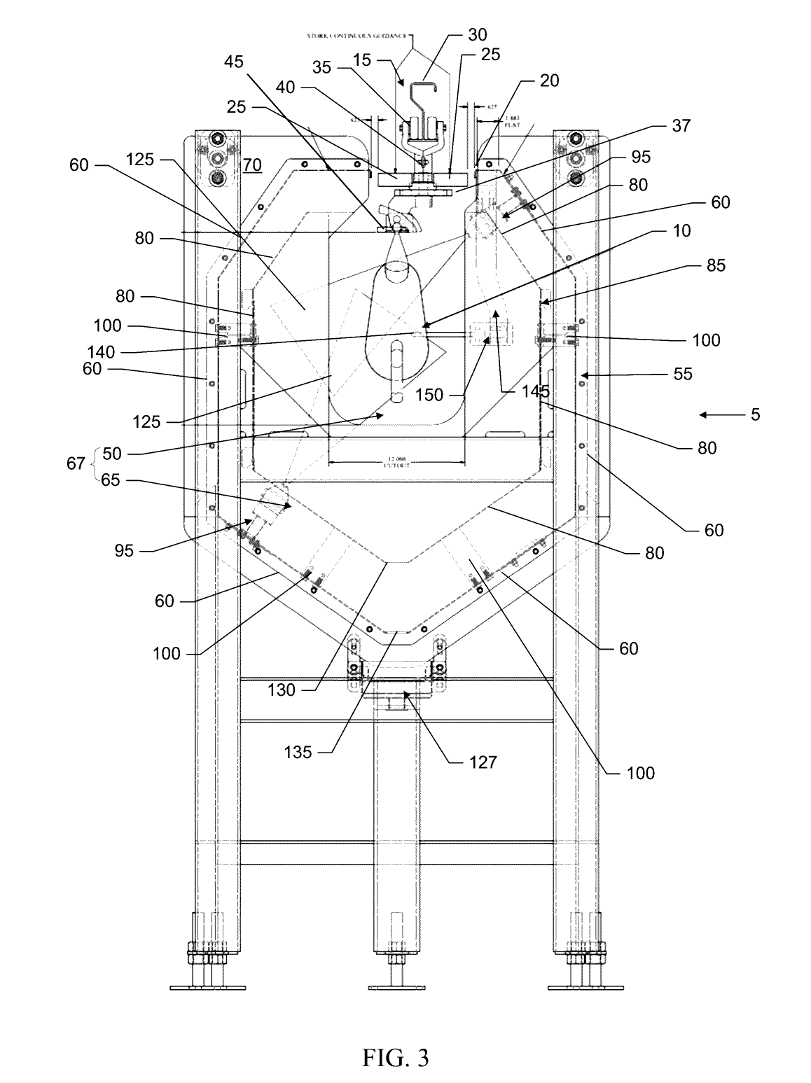

The conveyor 15 may further include at least one guide 25 for stabilizing the poultry 10 or other article and directing the articles along the conveyor. The guides 25 may contact the pulley members 35 or a portion thereof for controlling the lateral movement of the poultry 10 or other articles. In some embodiments, flanges or the like (e.g., flanges 37 shown in FIG. 3) may assist with stabilizing the poultry 10 and may additionally or alternatively provide a mounting point for the clamps 45. In some embodiments, the guides 25 may cover a portion of the opening 20 in the treatment cabinet 5 to minimize or prevent the release of airborne treatment agent into the surrounding environment.

Turning to FIG. 3, a front view of an embodiment of the treatment cabinet 5 is shown. In some embodiments, the conveyor assembly 15 may be partially disposed in the opening 20 at the top of the treatment chamber. As shown in FIG. 3, the guides 25 may have a narrow clearance between the edges of the opening 20 and the pulley members 35 to reduce leakage of the treatment agent from a treatment chamber 50. Alternatively, the entire conveyor may pass through the cabinet such that the conveyor is surrounded by the cabinet structure. (e.g., as shown in FIGS. 8-12).

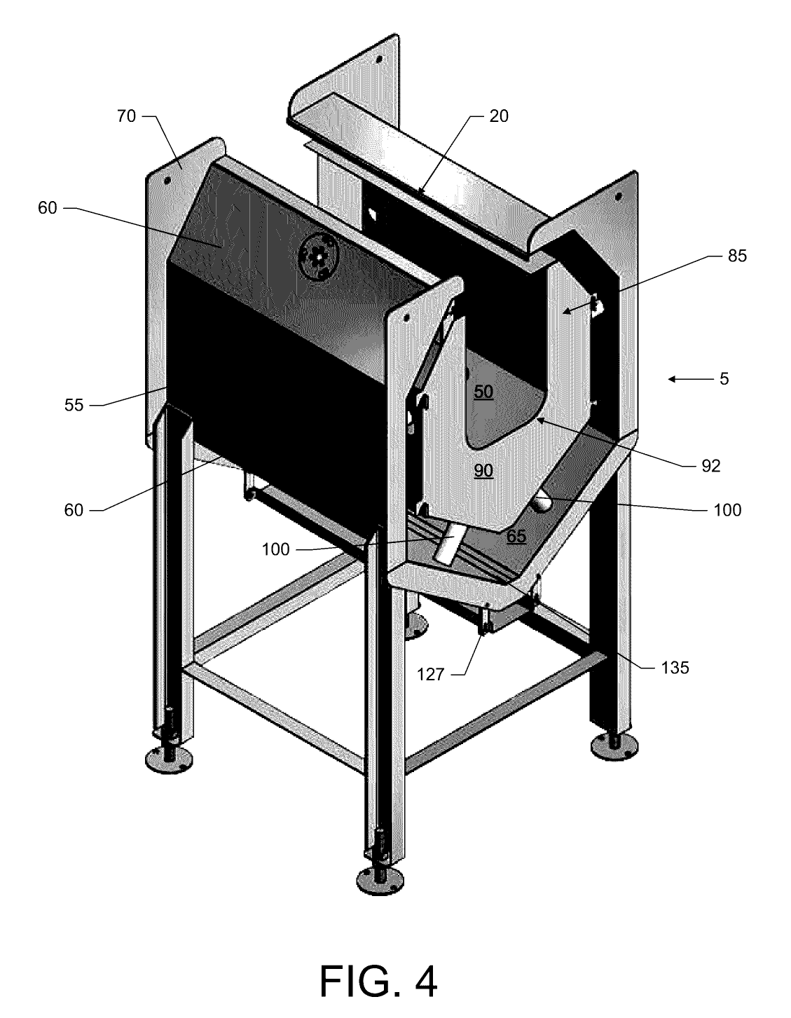

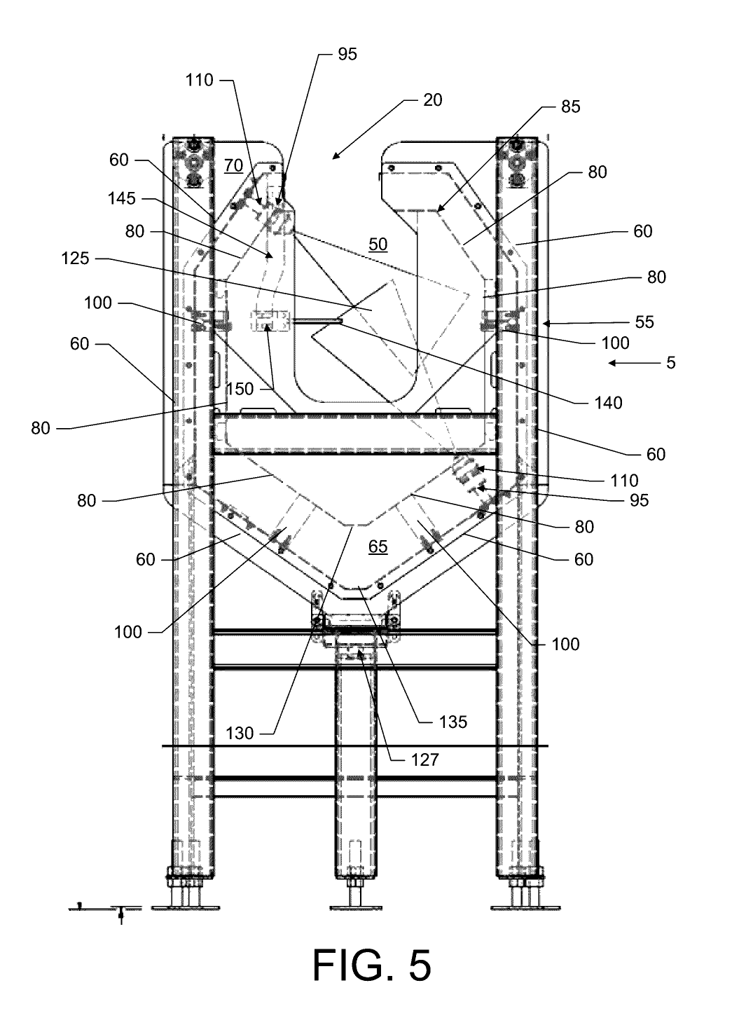

With reference to FIGS. 3-7, several embodiments of the cabinet 5 are shown. The cabinet 5 may include an outer shell 55 defining an outer cowling of the cabinet. The outer shell 55 may include one or more wall segments 60 that at least partially surround a cavity 67 (e.g., treatment chamber 50 and/or outer cavity 65) of the cabinet 5. In some embodiments, the wall segments 60 may be formed as one or more continuous sections of cowling around the cavity and may or may not have joints there-between. The outer shell 55 may further include one or more flanges 70 on one or more sides thereof that engage other components of the treatment system. In some embodiments, the outer shell of a cabinet will form a cavity that is the treatment chamber wherein the inner plate or series of inner plates are disposed within the cavity and in the treatment chamber.

In some embodiments, as shown in FIGS. 3-7, the outer shell 55 may be substantially tube shaped to allow food products 10 and other articles to pass linearly from end to end of the cavity 67 (e.g., treatment chamber 50 and/or outer cavity 65). The outer shell 55 may alternatively be shaped to allow any other desired path for the conveyor 15 (e.g., a curved, angled, cylindrical, half cylindrical, channel or U-shaped path) or may include doors or openings along with shelves, stands, hooks, rods, or the like for positioning stationary articles for treatment. In some embodiments, the outer shell may include openings to accommodate gloves such that the outer shell forms the wall or barrier of a glove box for use in conjunction with manual labor. In some embodiments an end cap (e.g., the end cap 75 shown in FIG. 1) may also be included to define a narrower cutout (e.g., the cutout 77 shown in FIG. 1) to allow the poultry 10 or other articles to pass into the cavity 67 while preventing at least some release of the antimicrobial agent or other treatment agent from the cavity. As detailed below, an end cap (e.g., the end cap 75 shown in FIG. 1) may be positioned between multiple cabinet pieces (e.g., treatment cabinets and/or capture sections) and/or only at the end of a series of cabinets. In some embodiments, one or more cabinets may be configured with baffles to prevent escape of treatment agent from the cabinet through the cutout 77.

With reference to FIGS. 3-6, the cabinet 5 may include one or more inner plates 80 within the cavity 67 of the cabinet 5. The one or more plates 80 may be electrically charged to improve the efficiency of the treatment system as detailed herein. In some embodiments, for example as shown in FIGS. 3-6, the inner plates 80 may form an inner shell 85 at least partially surrounding a path of the poultry 10 or other articles through the treatment system and having surfaces (e.g., a flat or curved face of the inner plates) oriented towards the article being treated. The inner plates 80 may cooperate to define the treatment chamber 50 within an inner cavity between the inner plates. In some embodiments, the inner plates 80 may further include one or more end plates 90 bounding a front side and/or a rear side of the treatment chamber 50. The end plates 90 may include a cutout opening 92 for accepting the articles to be treated and the plates may be used to prevent excess treatment agent from leaving the treatment chamber 50. In some embodiments, multiple cabinets 5 may be installed in series with or without end plates 90 between them. In some embodiments, the inner plate 80 may be provided opposite a spray nozzle 95 relative to the position of the poultry 10 or other article to be treated. As detailed below, the inner plates 80 may be given the same polarity as the antimicrobial agent or other treatment agent to reflect excess treatment solution back towards the articles. Charging the inner plates with a same polarity (e.g., both the agent and the plates being negatively charged) may cause less treatment agent to adhere to the cabinet and may reflect and focus the treatment agent onto the articles being treated. In some embodiments, the inner plates 80 may be given the opposite polarity (e.g., in a capture section 160 shown in FIG. 1) to the antimicrobial agent or other treatment agent to collect excess treatment solution.

The inner plates 80 may be connected to and supported by the outer shell 55 via one or more insulating members 100. The insulating members may support the inner plates 80 at a predetermined distance from the outer shell 55 (e.g., to prevent electrical arcing). The outer cavity 65 may be defined between the inner plates 80 and the outer shell 55. In some embodiments, the insulating members 100 may electrically isolate the inner plates 80 from the outer shell 55. As detailed below, in some embodiments the outer shell 55 may be electrically grounded, and the inner plates 80 may be charged. In some embodiments, with reference to FIG. 7, the insulating members 100 may include charging elements 105, which apply an electrical charge to the inner plates 80. The inner plates 80 may be latched, hooked, or otherwise removably attached within the cabinet 5 to allow easy removal for cleaning.

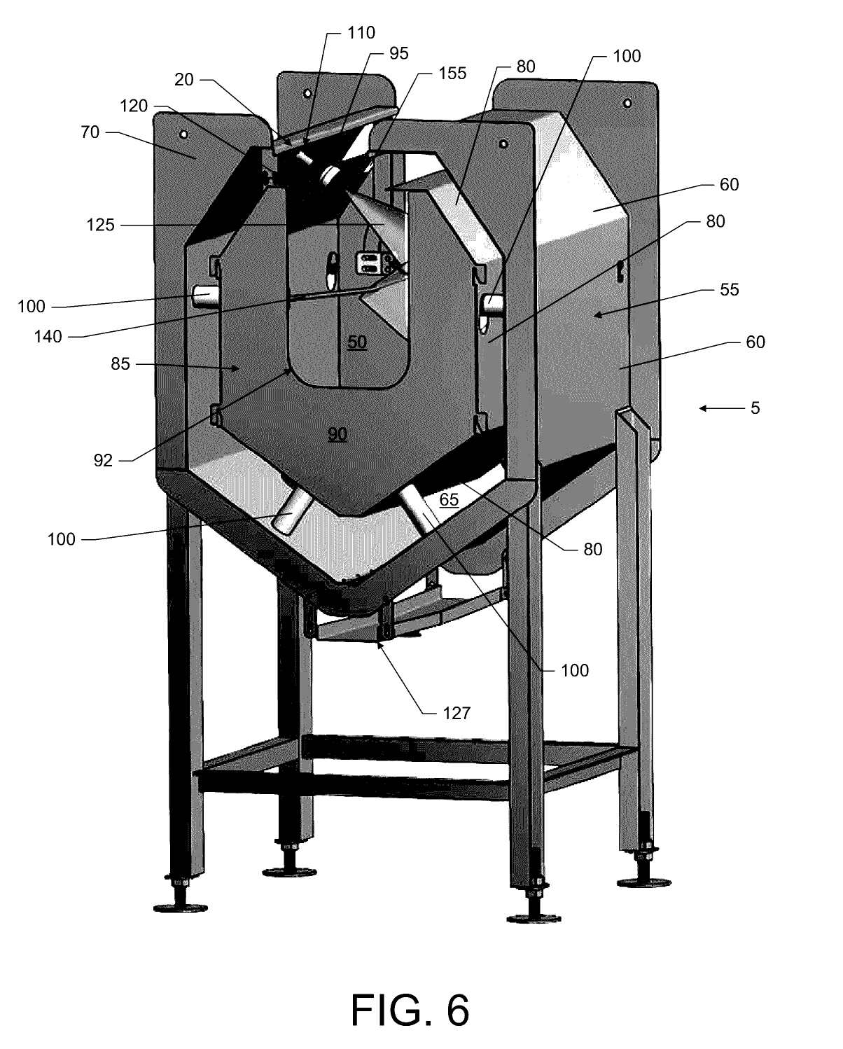

In some embodiments, the inner plates 80 may be substantially planar. In some other embodiments, the inner plates may be curved, at least partially cylindrical, at least partially spherical or hemispherical, or other shapes and configurations for focusing and repelling or reflecting the agent onto the articles being treated. In some embodiments a normal vector to the surface of the one or more inner plates 80 may be substantially aligned with the articles being treated. In some embodiments, the inner plates may each be compromised of one or more inner plates of different shapes or configurations such as for example, a cylinder mitered and coupled with another cylinder to form an L shaped cylindrical plate or a cylinder joined with a partially cylindrical shape. In some further embodiments, the one or more inner plates 80 may be oriented such that a normal vector to the surface of the one or more inner plates is oriented between the articles being treated and one or more of the nozzles 95 to reflect the spray from the nozzles onto the article. In some embodiments, the one or more inner plates 80 may be located in an opposite semi-cylinder (e.g., opposite half of the treatment area 50) relative to one or more nozzles 95. The shapes of the inner plates 80 may depend upon the shape of the cabinet and outer shell, and may depend upon the type and shape of conveyor (or lack thereof) of the articles through the cabinet. For example, in embodiments using a conveyor assembly 15, the inner plates may form a tube or cylinder around the path of the articles being treated. In embodiments using a conveyor belt having articles resting on top of the belt, a tube or cylinder of one or more inner plates may be formed over the belt. Examples of such embodiments are described below with reference to FIGS. 8-12. In some embodiments, the inner plates may be configured with openings to accommodate, spray nozzles, charging bodies, gloves (as in the case of a glove box), robotic arms, and/or other processing mechanics. In some embodiments the openings may be sealable. FIG. 6 depicts an example of an opening 120 for a spray nozzle. As will be readily appreciated by one of ordinary skill in the art, the number of openings in the inner plates can include any number of openings to accommodate any tool or other element necessary to perform a food processing step.

In some embodiments, more than one inner plate will have more than one charge of the same polarity with different degrees of charge in order to focus a higher amount of treatment agent on a desired part of an article being treated. For example, one inner plate may be charged at +2 kV and another inner plate charged at +4 kV.

With reference to FIGS. 3 and 5-7, a spray assembly is shown 110 for applying the antimicrobial agent or other treatment agent to the article(s) to be treated. The spray assembly 110 may include the one or more nozzles 95, which are configured to apply the treatment agent to the poultry or other article. In FIGS. 3 and 5-7, two nozzles on the spray assembly are shown. In some embodiments, the nozzles 95 may spray (e.g., by atomizing, aerosolizing, misting, or otherwise releasing the antimicrobial agent or other treatment agent) into the treatment chamber 50. The spray assembly 110 may include conductive elements for applying a charge to the treatment agent. In some embodiments, the conductive element may be in or adjacent the nozzles 95 (e.g., in nozzle tip 115). In some other embodiments, the conductive element may be positioned upstream of the nozzles 95. The conductive elements may apply a charge to the antimicrobial agent or other treatment agent prior to or after the agent is aerosolized. In some embodiments, the nozzles 95 may be attached to the outer shell 55 and may protrude through an opening 120 in the inner plates 80. In some other embodiments the nozzle 95 may be attached to the inner plates 80. The nozzles 95 may define one or more spray zones 125 in the treatment chamber 50 for covering the poultry or other articles to be treated. The spray assembly 110 may include a storage tank (not shown) or feed line (not shown) for storing and/or delivering the treatment agent to the nozzles 95, and the spray assembly may include one or more pumps, compressors, gas reservoirs, or other propellants for propelling the antimicrobial agent or other treatment agent. In some embodiments, a control system, e.g. PLC control system, and or user interface may be included to control the one or more pumps, compressors, gas reservoirs, or other propellants for propelling the antimicrobial agent or other treatment agent.

Spray assembly 110 and nozzles 95 may further include a mixing system for mixing the concentrations of treatment agents. For example, a concentrated treatment agent may be mixed with water to a treatment concentration before spraying. In some embodiments, a ceramic-based mixing system, such as a mixing pump may be used to mix and spray the treatment agent, including the mixed concentrate and water, onto the articles. For example, a Fluid Meterinc, Inc.® ceramic-based mixing pump or other valveless metering pumps may be used. Pumps with valves may also be used. Any other mixing system or method may also be applied to the spray system 110. In some embodiments, a solenoid valve may be included in the spray nozzles 95 to control the cloud of spray mist. For example, if the conveyor 15 stops or no article is present in the cabinet 5, the spray nozzles 95 may cease to spray to conserve treatment agent and minimize excess spraying onto the cabinet components. Similarly, the spray nozzles 95 may begin spraying several seconds before an article enters the cabinet 5 to fully develop the spray within the treatment chamber 50. In some embodiments, the mixing system may include a water pump with programmable flow and one or more pumps for concentrated treatment agent or components of a treatment agent with programmable flow.

In some embodiments the mixing system may be controlled by a user via a user interface adapted to allow the user to control the flow rates of one or more pumps for water, concentrated treatment agent or components of a treatment agent, thereby controlling the concentration of the treatment agent or agents being sprayed on an article. In alternative embodiments, the concentration of the treatment agent may be predetermined and the water pump turned off and the mixing step bypassed.

In some embodiments the spray assembly may include a programmable compressor capable of applying a predetermined or variable pressure to the treatment agent. The range of pressure applied to the treatment agent may be in the range of about 10 psi to about 60 psi, but are preferably in the range of about 20 psi to about 45 psi.

In some embodiments with one or more spray nozzles, a control system may be used to monitor the charges applied to each spray nozzle that imparts a charge to the treatment agents being spray, the flow rate of each spray nozzle, and the air pressure that is used to atomize the treatment agent into a mist for spraying. The charges, flow rates and air pressure may all be displayed in a user interface for control by a user.

In some embodiments, the spray assembly may be fitted with one or more valves, or other means that one of ordinary skill in the art would readily appreciate for controlling the flow of treatment agent, through one or more spray nozzles 95. Spray nozzles in the same embodiment may have different flow rates, e.g. in an embodiment with four spray nozzles, each may have a different flow rate. The preferred range of the flow rate of treatment agent through a spray nozzle may depend on the angle dispersion in the case of a conical shape spray nozzle, i.e. wider angle cones that disperse over a larger area may have a higher flow rate. Flow rates for cone spray nozzles may be between about 50 mL/min per spray nozzle to about 300 mL/min per spray nozzle. The preferred flow range of treatment agent through a spray nozzle may also depend on the configuration of the cabinet, one or more inner plates, the article being treated, or other factors that one of ordinary skill in the art would readily appreciate.

With reference to FIGS. 3-7, some embodiments of the treatment system may include one or more collectors 127 for collecting excess treatment agent for reuse or recycling. In some embodiments, the collectors may include one or more pumps or siphoning devices. In some other embodiments, as shown in FIGS. 3-7, the collectors 127 may include one or more channels, drains, trays, tanks, or the like for receiving and transporting the excess treatment agent from the cabinet 5. In some embodiments the inner plates 80 may define one or more upper drainage openings 130 for allowing the excess treatment agent to escape the treatment chamber 50. As detailed below, the inner plates 80 may repel the charged treatment agent and cause the condensing treatment agent to flow or be repelled or reflected towards the articles to be treated and/or the upper drainage opening 130. The outer shell 55 may additionally or alternatively include one or more lower drainage openings 135 for allowing excess treatment agent to escape the outer cavity 65. In some embodiments, the upper drainage opening 130 and/or lower drainage opening 135 may be disposed proximate a bottom of the respective inner plates 80 and outer shell 55 to allow deposited treatment agent to flow downward, while minimizing the release of airborne treatment agent. Moreover, the inner plates 80 and/or outer shell 55 may be sloped downwardly to channel liquid treatment agent to the drainage openings 130, 135. The collectors 127 may be disposed adjacent one or both of the drainage openings 130, 135 for receiving excess treatment agent.

Turning to FIGS. 3 and 5-7, a charging rod 140 is shown at least partially disposed within the treatment chamber 50. In some embodiments, the charging rod 140 may contact the articles to be treated (e.g., the poultry 10 shown in FIGS. 1-2) to apply a charge to the articles as detailed below. In some embodiments, the charging rod may be supported by one or more supports 145 and may further include an adjustment mechanism 150 (e.g., a locking hinge, pivoting junction, or collection of fasteners) for controlling the position of the charging rod 140. In some embodiments the supports 145 and/or adjustment mechanism 150 may be partially disposed outside the treatment chamber 50. In some embodiments, the supports 145 may be attached to the outer shell 55. In such embodiments, a cutout 155 may be provided in the inner plates 80 to accept the supports 145, adjustment mechanism 150, and/or charging rod 140. In some alternative embodiments, the supports 145 may be attached to the inner plates 80. The charging rod 140 may be configured to project into the path of the articles to be treated (e.g., the poultry 10 shown in FIGS. 1-2) to ensure a charge is applied to the articles. In some embodiments, two or more charging rods 140 may be used in the treatment system.

In some embodiments, the charging rod 140 may be connected at both ends to the supports 145, as shown in FIGS. 3 and 5-7. In such embodiments the charging rod 140 may be oriented parallel to the direction of travel of the articles being treated. In other embodiments the charging rod 140 may be oriented at bias angle from an axis perpendicular to the direction of travel of the articles. In some embodiments, the charging rod 140 may be connected at one end, and may be spring-loaded, finger-like rods, pins configured to touch the poultry or other articles to be treated with its tip or a brush. In some embodiments, the charging rod 140 may be one or more brushes with bristles configured to touch the articles along their top, bottom, or sides. In such embodiments, the brushes may be spring loaded to engage and maintain contact with the articles to apply a charge.

The charging rod 140 may ensure that the treatment agent has a greater attraction for the product than the conveyor 15 or surrounding materials. In some embodiments the charging rod 40 will be configured to ground or positively charge the product such that static charges deposited by negatively charged material will be continuously removed. In such embodiment the article being treated will continuously attract negatively charged treatment spray, the articles repulsion of treatment spray will be minimized thereby enhancing uniformity of coverage. In some embodiments, the portions of the charge rod not contacting the articles may be insulated to reduce attraction of agents towards other areas of the rod. For example, in embodiments using brushes, only the brush tip may be exposed to the treatment agent, while the other sides of the brushes may be insulated.

The charging rod 140 may be connected to a power source (not shown) to receive a charge. In some embodiments, an insulator may be positioned between the charging rod 140 and the remainder of the cabinet 5 (e.g., where the charging rod meets the adjustment mechanism 150, where the adjustment mechanism meets the supports 145, where the supports meet the outer shell 55 or inner plate 80, or at any intermediate position) to electrically isolate the charging rod. In some embodiments, the charging rod may be a part of the conveyor (e.g., the conveyor assembly 15 shown in FIGS. 1-2). For example, with reference to FIG. 2, the clamps 45 may be configured to apply an electric charge to the poultry 10 or other article to be treated. In some embodiments the charging rod 140 may be attached to the cabinet 5 or adjacent the cabinet via any other attachment mechanism. In some embodiments, the poultry 10 or other article may be continuously charged in the treatment chamber to avoid the articles building up charge from the spray mist and repelling the mist. For example, the article may be continuously grounded or positively charged to avoid building up negative charges from negatively charged spray mist so that repulsion of treatment spray will be minimized thereby enhancing uniformity of coverage. In some embodiments, the poultry 10 or other article may be charged before entering the treatment chamber 50.

As will be readily appreciated by one of ordinary skill in the art, in addition to a charging rod, the charging of an article may be accomplished using any number of devices that can apply a charge including chargeable bodies in the shape and configuration of rods, pins, brushes, flanges, rods or brushes including multiple pins, or a combination of one or more thereof, and such devices may be configured to telescope, retract, or be positioned at an angle. Chargeable bodies may be integrated in, attached to, or otherwise disposed within the cabinet and disposed at least partially within the cavity of the outer shell, or at least partially within a treatment area, such as the treatment chamber 50.

The spray assembly 110 and/or charging rod 140 may include an electrical control system for applying a charge to the treatment agent and controlling the charge-to-mass ratio of the treatment agent. The amount of charge applied to the treatment agent and/or articles may be controlled based upon the flow rate of the treatment agent and the speed of the conveyor (e.g., the desired treatment speed of the system). For example, Electrostatic Spraying Systems® manufactures nozzles for electrostatic spraying applications. For a negatively charged treatment agent, a charge may be applied at −8 μA for a liquid flow of 90 mL/min to produce a −5.3 charge-to-mass ratio. Similarly, the manufacturer suggests a charge to be applied at −15 μA for a liquid flow of 180 mL/min to produce a −5.0 charge-to-mass ratio. The higher the absolute value of the charge-to-mass ratio of the mist cloud, the higher the efficacy of the electrostatic spray and its uniformity of coverage. In some embodiments, the spray nozzles will be configured to produce spray mist with negative polarity. The range of charge-to-mass ratio may have absolute values greater than 10 mC/kg with negative polarity. The value of the charge-to-mass ratio may be achieved by adjusting air pressure and hence air flow rate and the flow rate of the treatment agent. The amount of air pressure will affect the droplet size of the spray mist and hence the mass of spray mist in a given volume of a mist cloud. The power supply may provide constant power to a spray nozzle and therefore approximately similar static charge to the flowing liquid (varying based on the conductivity of fluid being sprayed).

In some embodiments the electrical control system may also control application of a charge to the inner plates and/or application of a charge to a charging body that applies a charge an article. In some embodiments, a user interface with PLC controls or other controls may be provided to control the charge applied to the inner plates or article.

A higher charge-to-mass ratio may also be used to facilitate interaction between the treatment agents and articles and/or to expedite the treatment process. The flow rate may be chosen based upon the desired treatment time of the articles (e.g., the speed of the conveyor and the length of the treatment chamber) and/or the rate at which the treatment agent adheres to the articles. Similarly, in embodiments that apply a charge to the article, the charge may be controlled based upon the speed of the article or expected treatment duration and based upon the flow rate and concentration of the liquid spray. This may be achieved by adjusting the speed of the conveyor carrying the article, and sizing the treatment chamber for a sufficient number of nozzles to provide treatment agent mist sufficient to provide uniform coverage to the article.

In some embodiments, the article to be treated may not be charged and/or may be grounded. In such embodiments, the charged spray may induce a charge in the neutral articles and thereby adhere to the articles. These embodiments may not include a charge rod or other device for charging the articles, and may only charge the spray instead.

As detailed herein, in some embodiments, the cabinet 5 may include one or more flanges (e.g., flanges 70 shown in FIG. 3), fasteners, and/or any other connecting mechanism for attaching additional components to one or more sides of the cabinet. In such an embodiment, the treatment system may be modular and customizable. For example, two or more cabinets 5 may be joined to increase the length of their collective treatment chambers 50.

Turning back to FIG. 1, in some embodiments, one or more capture sections 160 may be coupled to either or both an upstream (e.g., pre-treatment) or downstream (e.g., post-treatment) side of the cabinet 5. The capture sections 160 may couple to the cabinet 5 (e.g., via flanges 70) and may capture airborne antimicrobial agent or other treatment agent that escapes the cabinet 5. As detailed below, in some embodiments, the capture sections 160 may be structured substantially the same as the cabinet 5 (e.g., having an outer shell and inner plates), and in some embodiments, the capture sections 160 may be reconfigured cabinets 5 for collecting excess treatment agent rather than spraying treatment agent.

In some embodiments, the cabinets 5 and/or capture sections 160 may be modular and may include substantially the same external dimensions to promote interchangeability. The cabinet(s) 5 and capture section(s) 160 may be configured in any of a number of ways depending on the amount of treatment agent to be applied and the amount of treatment agent escaping the cabinet(s). For example, in some embodiments, a single cabinet 5 may be used with capture sections 160 on either side thereof for catching excess treatment agent leaving the cabinet. In some embodiments, two or more cabinets 5 may be used with at least one capture section on either end of the assembly. In some embodiments, multiple different antimicrobial or other treatment agents may be used in sequential cabinets and may optionally have capture sections between the cabinets. In some embodiments, multiple capture sections may be used on one or both the upstream and downstream sides of the cabinet as needed. In embodiments having different transporting and/or positioning devices, the capture sections may be positioned near any opening in the cabinet 5.

The one capture section may include one or more inner plates disposed within the cavity of the capture section, and the inner plate may be electrically isolated from the outer shell of the capture section. The inner plate of the capture section may be charged with a charge opposite of the treatment agent so as to attract excess treatment agent that is not applied to an article. The inner plate of the capture section may be configured similar to the inner plate in the section of the cabinet where the treatment agent is sprayed (e.g. as shown in FIGS. 3-6 as inner plate 80 forming the treatment chamber 50). In some embodiments, the inner plate of the capture section may be configured different than the inner plate in the section of the cabinet where the treatment agent is sprayed. The inner plate of the capture section may be of various shapes and configurations with openings in various locations. Shapes of the inner plate of the capture section may include but not limited to cylindrical, semi-cylindrical, channel shaped, or U-shaped. The inner plate of the capture section may have a funnel shape adapted to direct the flow of sprayed treatment agent into a funnel for collection. In another embodiment the at least one inner plate of the capture section may have the form of a mesh screen. In yet another embodiment the inner plate of the capture section may be adapted to move in a centrifugal direction.

In some embodiments, the at least one capture section may include at least a first capture section integrated with or attached to a first side of the cabinet containing a treatment chamber and a second capture section integrated with or attached to a second side of the cabinet. The first side may be upstream of the cabinet in a treatment process and the second side may be downstream of the cabinet in the treatment process. In some embodiments, the capture section may include separators for separating the treatment agent in a liquid mist or atomized liquid form from the air.

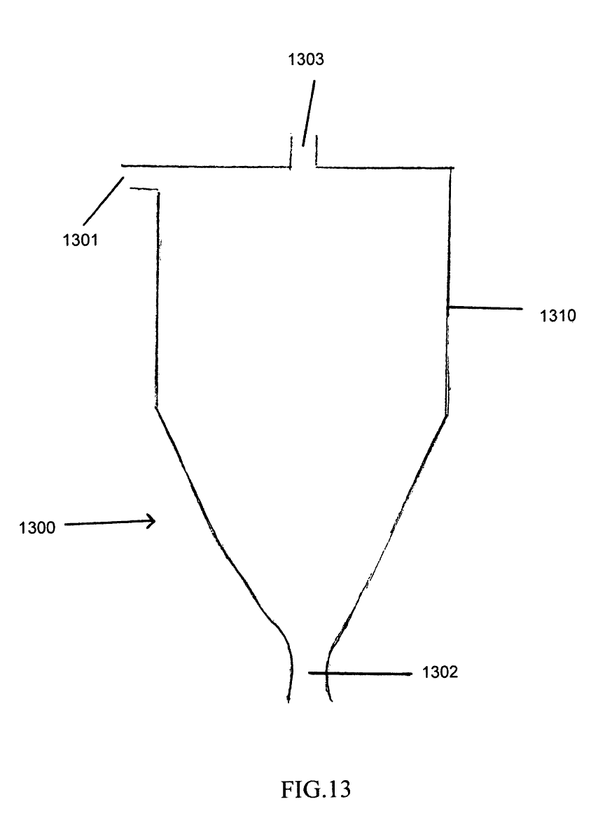

With continued reference to FIG. 1, in some embodiments, a cyclone separator (not shown) may be additionally or alternatively included in the treatment system 1 to eliminate any escape of agents into surrounding air that may pose environmental hazards for employees. Referring to FIG. 13, the cyclone separator 1300 may draw the air containing any mist into an air and mist opening 1301 and separate the antimicrobial spray or other treatment agent from the air. The walls 1310 of the cyclone separator can be charged with an opposite charge compared to the agent(s) in order to attract the mist to the walls and collect them at the bottom of the cyclone separator where the mist exits the separator at the mist exit 1302. The air may escape through the air exit 1303. In such instances, to avoid any electrocution of the employees, the cyclone separator may be surrounded by insulation, an insulating coating or an electrically grounded cabinet which is electrically isolated from the inner cyclone separator walls.

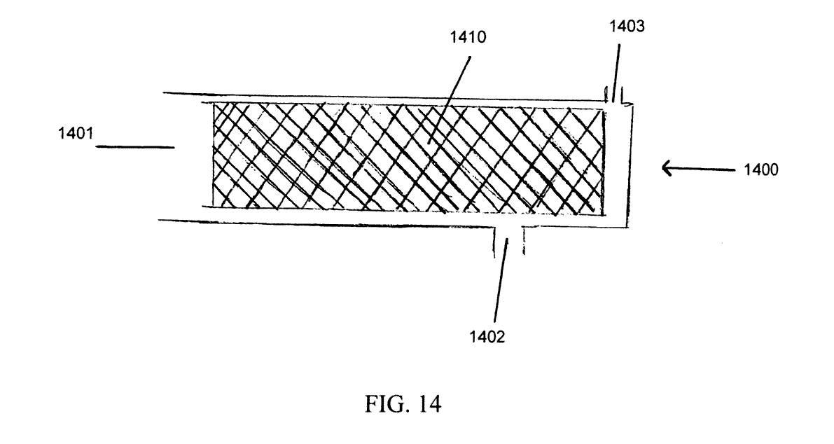

With reference to FIG. 1, in some embodiments, a mesh separator (not shown) may be additionally or alternatively included in the treatment system 1 to eliminate any escape of agents into surrounding air that may pose environmental hazards for employees. Referring to FIG. 14, the air containing any mist may be drawn into a mesh separator 1400 through an air and mist opening 1401 and the antimicrobial spray or other treatment agent may be separated from the air. The mesh separator may include a mesh screen 1410 disposed within the walls of the mesh separator. The mesh screen may have a large surface area configured so that all the air containing a mist of treatment agent may pass through the mesh. The mesh screen may be made of conductive material such as stainless steel. The mesh screen 1410 can be charged with an opposite charge compared to the agent(s) in order to attract the mist to the screen and deposit the mist thereby separating the treatment agent from the air and conveying it toward the mist exit 1401. The air may escape through the air exit 1402. In some embodiments the mesh screen may be electrically isolated from the walls of the mesh separator. In some embodiments one or more of the walls of the mesh separator may also be charged to aid in drawing the liquid into the mist exit. In alternative embodiments, the screen upon which mist is deposited may be a series of baffle walls, rods, screens or other structures that may be charged and configured in different directions in a manner configured to create surface area for the mist to deposit on.

In some embodiments, spray mist may be exhausted through a vertical column, wherein treatment agent will dissolve in water while air will bubble through the column. In such an embodiment, the water in the column may need replenishment with clean water to provide it with the ability to dissolve additional treatment agent. A separator using vertical column may be attached to the cabinet in a manner disclosed in one or more embodiments described attachment of a separator or by any means known or hereafter discovered to accomplish such purpose.

With reference to FIG. 1, in some embodiments a cyclone separator or mesh separator may be attached to the opening 20 in the cabinet 5 to collect and remove excess treatment agent from the air. In some alternative embodiments, a cyclone separator or mesh separator may be attached to or adjacent the flanges 70 of the cabinet 5. In some embodiments, a hood (not shown) may be place above opening 20 and the cyclone separator or mesh separator attached to the hood via one or more pipe outlets. The pipe outlets may be attached to the portion of the hood located above the capture sections 160. The outlets may be affixed with valves for opening and closing the pipes, preventing air and mist from escaping when closed. In some embodiments, one or more pipe outlets may be attached to the hood above the opening 20 and the pipes may be connected to a pump that applies vacuum suction to draw the mist and air through the pipe outlet and into the cyclone separator or mesh separator. In some embodiments, the pipe outlets may convey the mist and air outside a room or the plant housing a treatment system 1 to the location of the cyclone separator or mesh separator.

With reference to FIG. 8, aspects of one embodiment of the treatment system are depicted that may be employed for treating raw or RTE meat parts, fruits, vegetables or other food products and/or food processing equipment or components thereof. The system includes a cabinet 800, having a half-cylindrical or dome shape with an outer shell 801 of similar or same shape to the cabinet and an inner plate 802 disposed therein. The outer shell 801 of the cabinet 800 is grounded. The inner plate 802 also has a half cylindrical or dome shape, forming a treatment chamber 850 and includes one or more openings 823 for one or more spray nozzles 803. The inner plate 802 may be negatively or positively charged such that its charge is the same in polarity to the charge of the treatment agent 813 being sprayed through the spray nozzle 803. A conveyor 804 may be included for transporting articles such as food through the cabinet for spraying with a treatment agent 813. The conveyor 804 may be a belt but may be any suitable means for transporting and/or positioning the articles may be used, such as, for example, a hanging or flat conveyor belt, a cabling system, or any means now known or later discovered for such purpose. Disposed inside the treatment chamber is a brush 805 with chargeable brush bristles 815. The brush bristles may be made of conductive material and may be flexible. The brush bristles 815 may be charged with a charge opposite to the charge of the treatment agent being sprayed through the spray nozzle 803. The parts of the brush that hold the chargeable bristles may be insulated or made of non-conductive material. In other embodiments the entire brush 805 may be charged. The distance of the brush 805 and the conveyor 804 may be adjustable to accommodate different articles. The distance between the spray nozzle 803 and the conveyor 804 may also be adjustable to accommodate different articles. The configuration of spray mist of the treatment agent 813 may be in a conical shaped mist but the dimensions and shape of spray mist may be configurable to accommodate different shapes and types of products. The treatment agent 813 may be charged at about −2 kV or greater. The inner plate 802 may be charged at −2 kV or greater to repel the treatment agent mist. The higher the negative charge of the inner plate 802, the greater the repulsive force. The conveyor 804 may be grounded and hence the charged treatment agent mist charged with −2 kV will be attracted toward the conveyor driven by the potential difference of 2 kV [0 kV−(−2 kV)]. The brush bristles 815 may be charged with a positive charge (opposite of the treatment agent 813) of about +2 kV or higher. In some embodiments, the entire brush 805 may also be charged. An article passing through the treatment chamber 850 on the conveyor may be positively charged by one or more of the brush bristles holding at +2 kV charge so that the article is charged with a +2 kV charge. A spray mist charged with −2 kV being sprayed on an article charge with a +2 kV charge will be driven towards the article with a potential difference of 4 kV [2 kV−(−2 kV)]. The higher the voltage of the brush 805 or brush bristles 815 and hence the products, the higher the attraction to the spray mist. Hence, in this example, the treatment agent 813 is twice more attracted to the product than the conveyer 804. The brush 805 and the brush bristles 815 if charged with a +2 kV charge will also attract the negatively charged treatment agent 813, such attraction is beneficial as the brush and brush bristles would be continuously sanitized and prevent cross contamination. The design of the brush 805 and the brush bristles 815 may be designed so that they are thin and hence minimizing surface area that can attract treatment agent treatment agent and leaving more treatment agent to adhere to the articles. The design of the brush 805 and the brush bristles 815 may be flexible so that they can touch articles of varying size. The design of the brush 805 and the brush bristles 815 may be flexible so that they can continue to touch articles as they pass over a certain distance under the cloud of a spray mist. In other embodiments, the brush or bristles may be rigid based on the needs of the application as one of ordinary skill in the art would readily appreciate. The embodiments described with reference to FIG. 8 may have one or more of the features of other embodiments described herein, including but not limited to, capture sections including one or more inner plates that are positively charged to deposit and extract the treatment agent in the spray mist. The inner plate of the capture sections may be electrically isolated from the inner plate of the treatment chamber 805 by any suitable means such as insulating between sections of the inner plate of the treatment chamber and the inner plate of the capture section. The capture section may have pipe outlets connected to separator as described herein. In alternative embodiments, the inner plate may be a partial half cylinder such that the treatment chamber is partial form by the wall of the outer shell. In some embodiments as described herein, the capture section may have multiple inner plates electrically isolated from multiple inner plates of the treatment chamber.

With reference to FIG. 9, aspects of one embodiment of the treatment system are depicted that may be employed for treating raw or RTE meat parts, fruits, vegetables or other food products and/or food processing equipment or components thereof. The system includes a cabinet 900 having cylindrical shape with an inner plate 902 disposed therein. The outer shell 901 is of similar or same shape to the cabinet 900 and is grounded and defines a cavity. The inner plate 902 also has a cylindrical shape, forming a cavity that is a treatment chamber 950 and includes one or more openings 923 for one or more spray nozzles 903. The inner plate 902 may be negatively or positively charged such that its charge is the same in polarity to the charge of treatment agent being sprayed through the spray nozzle 903. A conveyor 904 may be included for transporting articles such as food through the cabinet 900 for spraying with a treatment agent 913. The conveyor 904 may be a belt but may be any suitable means described herein, or any means now known or later discovered for the purpose of transporting articles through the cabinet 900 for treatment. The conveyor may be grounded and the article 910 may also be grounded. In some embodiments, no charge is applied to the article 910, and/or nothing is done to ground the article. Disposed in the treatment chamber 950 may include food processing equipment, such as a slicer, peeler or any number of pieces of equipment that one of ordinary skill in the art would appreciate a need for treating that equipment and the food processed in the equipment with a treatment agent. For example, in the case of a slicer being used for the processing of RTE meats that is disposed in or integrated with 900 such that the slicing blade is disposed in the treatment chamber 950, the sliding blade and the slices of RTE meats may be treated with a treatment agent, the conveyor 904 transporting the slices through the treatment chamber 950. Treatment with an antimicrobial treatment agent of parts of a slicer, including its slicing blade, prevents cross contamination and treatment on cut surface of the slices prevents the growth of bacteria improving storage life and safety. The embodiments described with reference to FIG. 9 may have one or more of the features of other embodiments described herein, including but not limited to, one or more capture sections in which one or more inner plates of the capture sections are charged opposite to the polarity of the treatment agent in order to deposit and extract the treatment agent in the spray mist. The capture section may have pipe outlets connected to separator as described herein.

In another embodiment, the treatment system depicted in FIG. 9 may include a sausage or hot dog peeler disposed in or integrated with 900 such that the peeler may be treated in the treatment chamber 950.

In another embodiment of the present invention, electrostatically charged treatment agent can be incorporated into the feeding tube or in the chamber inside of a sausage/hot dog peeler such as, e.g. the model 2800 Sausage Peeler manufactured and sold by Marel Townsend Further Processing B.V. and Townsend Further Processing Inc. Incorporating an antimicrobial treatment agent in this manner will coat the inside environmental surfaces of the peeler with the treatment agent so that niches for foodborne pathogens like Listeria monocytogenes are eliminated, resulting in reducing the risk of contamination of sausages and hot dogs. Also, during peeling, a sharp, very thin blade makes an incision in the sausage so that as the sausage moves through the peeler, the peeling elements can remove the casing. It is possible that during this incision, if the blade is contaminated, the organism can get inside the sausage hence protecting the microorganism from being treated with a treatment agent. Electrostatically applying the treatment agent in accordance with features of one or more embodiments described herein during the peeling operation will coat the outside surface of the sausage casing before it enters the peeling chamber of the peeler causing continuous sanitization of the interior of the peeling chamber, and uniformly coating the surface of the peeled sausage surface with the antimicrobial so it is protected from microbial growth including growth inhibition of bacteria such as Listeria monocytogenes and other spoilage bacteria such as lactic acid bacteria.

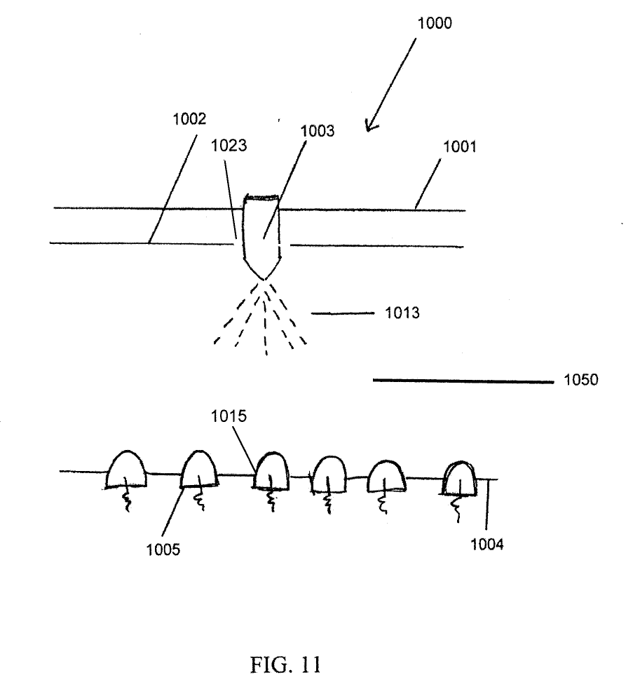

With reference to FIGS. 10 and 11, aspects of one embodiment of the treatment system are depicted that may be employed for treating raw or RTE meat parts, fruits, vegetables or other food products and/or food processing equipment or components thereof. The system includes a cabinet 1000 having half-cylindrical or dome shape with an inner plate 1002 disposed therein. The outer shell 1001 of the cabinet 1000 defines a cavity and is grounded. The inner plate 1002 also has a half cylindrical or dome shape, forming a cavity that is a treatment chamber 1050 and includes one or more openings 1023 for one or more spray nozzles 1003. The inner plate 1002 may be negatively or positively charged such that its charge is the same in polarity to the charge of treatment agent being sprayed through the spray nozzle 1003. A conveyor 1004 transporting articles such as food through the cabinet 1000 for spraying with a treatment agent 1013. The conveyor 1004 may be a belt but may also be any suitable means described herein, or any means now known or later discovered for the purpose of transporting articles through the cabinet 1000 for treatment. The conveyor may be grounded and the article carried on the conveyor may also be grounded. The conveyor 1004 may be a conveyor belt with perforations 1015 through which spring loaded pins 1005 may be used to charge food products placed on the conveyor belt. The spring loaded pins 1005 may be charge in opposite polarity to the charge of the treatment agent 1013 in a manner to cause the product on the conveyor to be attracted to the treatment agent more than the surrounding elements of the treatment chamber 1050. The embodiments described with reference to FIG. 10 may have one or more of the features of other embodiments described herein, including but not limited to, capture sections in which one or more inner plates of the capture sections are charged opposite to the polarity of the treatment agent in order to deposit and extract the treatment agent in the spray mist.

With reference to FIG. 11, aspects of one embodiment of the treatment system are depicted in a lateral cross section view of a cabinet 1000 that may be employed for treating raw or RTE meat parts, fruits, vegetables or other food products and/or food processing equipment or components thereof. The system depicted in FIG. 11 includes a cabinet 1000 having half-cylindrical or dome shape with an inner plate 1002 disposed therein. The outer shell 1001 of the cabinet 1100 is grounded. The inner plate 1002 also has a half cylindrical or dome shape, forming a treatment chamber 1050 and includes one or more openings 1023 for one or more spray nozzles 1003. The inner plate 1002 may be negatively or positively charged such that its charge is the same in polarity to the charge of treatment agent being sprayed through the spray nozzle 1003. A conveyor 1004 may be included for transporting articles such as food through the cabinet 1000 for spraying with a treatment agent 1013. The conveyor 1004 may be a belt but may also be any suitable means described herein, or any means now known or later discovered for the purpose of transporting articles through the cabinet 1000 for treatment. The conveyor may be grounded and the article being transported on the conveyor may also be grounded. The conveyor 1004 may be a conveyor belt with perforations 1015 through which spring loaded pins 1005 may be used to charge food products placed on the conveyor. The spring loaded pins 1005 may be charge in opposite polarity to the charge of the treatment agent 1013 in a manner to cause the product on the conveyor to be attracted to the treatment agent more than the surrounding elements of the treatment chamber 1050. The embodiments described with reference to FIG. 11 may have one or more of the features of other embodiments described herein, including but not limited to, capture sections in which one or more inner plates of the capture sections are charged opposite to the polarity of the treatment agent in order to deposit and extract the treatment agent in the spray mist, and/or pipe outlets connected to capture sections to connect separators as described herein.

In another embodiment of the present invention the electrostatic spraying of poultry parts can be integrated into a poultry processing line that includes either or both of manual and mechanical/robotic labor to cut and separate the poultry parts from a carcass. Flesh of a healthy animal is sterile, but when cuts are made, the poultry parts get contaminated. Material may be used to shroud or enclose parts of the cutting area of the processing line in a cabinet to accommodate electrostatic spraying of treatment agents onto knives and freshly cut surfaces of poultry in accordance with features of one or more embodiments described herein. A cabinet including glove boxes may also be used to prevent laborers from exposure to treatment agents. In a glove box, spraying of birds, poultry parts and cutting utensils could be done during or immediately after cutting.

With reference to FIG. 12, aspects of one embodiment of the treatment system are depicted that may be employed for treating for raw or RTE meat parts, fruits, vegetables or other food products. The system includes a cabinet 1200 and an outer shell 1201 both having the shape and configuration resulting from two cylindrical housings being joined at an angle to form an L-shape or near L-shape, the outer shell forming a cavity. The outer shell 1201 of the cabinet 1200 has an inner plate 1202 disposed in the cavity formed by the outer shell 1201. The inner plate 1202 has the shape and configuration resulting from two cylindrical housings being joined at an angle to form an L-shape or near L-shape. In some embodiments, the two cylindrical housings forming the cabinet 1200 and the inner plate 1202 need not be at 90 degree angle to form an L-shape, and for example they may be joined at a variety of angles, including, e.g. a U-shape or channel shape. The outer shell 1201 of the cabinet 1200 is grounded. The inner plate 1202 forms a cavity within the outer shell 1201 that is a treatment chamber 1250 and includes one or more openings 1223 for one or more spray nozzles 1203. One of ordinary skill in the art would readily appreciate that the one more spray nozzles may be place in any location in the treatment chamber 1250. The inner plate 1202 may be negatively or positively charged such that its charge is opposite in polarity to the charge of treatment agent being sprayed through the spray nozzle 1203. The spray nozzles may be configured with charging elements as described herein to apply a charge to the treatment agent 1213. A conveyor 1204 may be included for transporting articles such as food through the cabinet 1200 for spraying with a treatment agent 1213. The conveyor 1204 may be a belt but may also be any suitable means described herein, or any means now known or later discovered for the purpose of transporting articles through the cabinet 1200 for treatment. The conveyor may be grounded and the article 1210 may also be grounded. The 1200 may also include charged bodies such as a brush, rod, pins described herein for the purpose of applying a charge to article 1210 as it passes through the treatment chamber. Disposed in the treatment chamber 1250 may include food processing equipment, such as a slicer, peeler or one or more components of equipment that one of ordinary skill in the art would appreciate a need for treating that equipment and the food processed in the equipment with a treatment agent. For example, in the case of a slicer being used for the processing of RTE meats that is disposed in or integrated with 1200 such that the slicing blade is disposed in the treatment chamber 1250, the sliding blade and slices of RTE meat may be treated with a treatment agent, the conveyor 1204 transporting the slices through the treatment chamber 1250. Disposed in the treatment chamber a slicer may be a slicing assembly that includes a slicer with a slicing blade and one or more mechanical/robotic arms that hold the meat toward the slicing blade of the slicer. During slicing the treatment agent 1213 may be negatively charged and sprayed onto the slicer, slicing blade and/or meat. The slicer may either be grounded or more preferably positively charged. The inner plate 1202 may be negatively charged such that it repels the negatively charge treatment agent 1213 that is in mist form as it comes out of the spray nozzles 1203 and focuses the treatment agent on the unsliced meat, slices, and/or the slicer. The sliced meat can further be sprayed in the treatment chamber, during slicing, directly after slicing, and/or at a time after slicing, e.g., the slicer may be at or near the location 1251 of the treatment chamber 1250 where the two cylindrical housings forming the inner plate 1202 are joined at an angle; and the sliced meat may fall flat on the conveyor 1204 at the location 1252 in the treatment chamber 1250 where the conveyor changes direction and the sliced meat lying flat on the conveyor may be sprayed with the treatment agent with a spray nozzle configured in a location to effect a spray onto a slice of meat. In some embodiments, the conveyor 1250 may be mesh so that the RTE meat slices may be sprayed from both sides of the slice as it lays flat on the conveyor. In some embodiments, between two sections of the treatment chamber 1250 that contain spray nozzles 1203, the a slice of RTE meat may be flipped by mechanical means so that other side of the RTE meat slice may be sprayed. In some embodiments, multiple conveyors may be provided, for example, a conveyor that holds unsliced meat and a different conveyor for the slices, and in some embodiments, the two conveyors may have different configurations. Treatment with an antimicrobial treatment agent of parts of the slicer, including the slicing blade, prevents cross contamination and treatment on cut surface of the slices prevents the growth of bacteria improving storage life and safety. The embodiments described with reference to FIG. 12 may have one or more of the features of other embodiments described herein, including but not limited to, one or more capture sections in which one or more inner plates of the capture sections are charged opposite to the polarity of the treatment agent in order to deposit and extract the treatment agent in the spray mist. For example, in the embodiments described with reference to FIG. 12, the treatment agent 1213 may be charged at −2 kV, while the capture section shaped as a cylindrical housing may have an inner plate charged at +2 kV. The potential difference between the treatment agent 1213 and the inner plate of the capture section would be 4 kV thereby attracting the treatment agent 1213 mist toward the inner plate of the capture section, which may be configured to allow the treatment agent to deposit on the plate. The inner plate of the capture section forms a cavity that is a capture chamber, the capture chamber may be attached to means of sucking out air, e.g. a pipe attached to the capture chamber via an opening in the inner plate of the capture section wherein the pipe has vacuum suction applied to it. The suction means may also be configured to suck out the treatment agent 1213 mist. In designing a capture section with a suction means, care should be taken to minimize suction of mist from the treatment chamber 1250 as the time of residence of the treatment agent 1213 mist in the treatment chamber should be maximized so the mist adheres to the food products. The purpose of applying a suction means to create suction in the capture chamber is to capture excess mist that would otherwise escape the treatment chamber in the absence of suction in the capture chamber. The embodiments described with reference to FIG. 12 may have pipe outlets connected to capture sections to connect separators as described herein, such as a mesh separator or cyclone separator, or other separating technology that may be adapted in accordance with embodiments of this invention by charging elements of the separator to use electrostatic forces to aid in separating the treatment agent from the air.

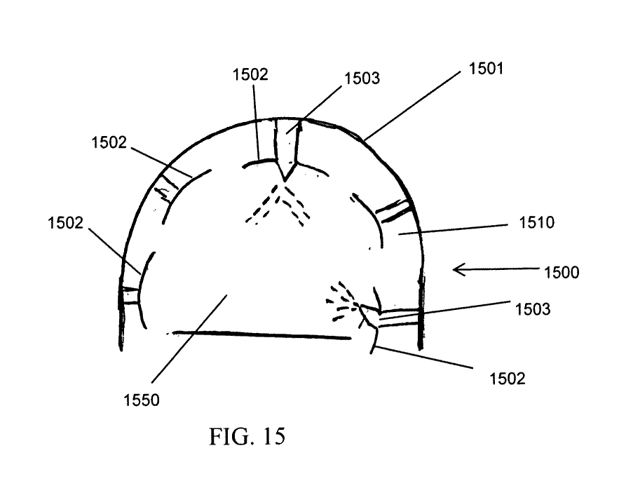

With reference to FIG. 15, aspects of one embodiment of the treatment system are depicted that may be employed for treating raw or RTE meat parts, fruits, vegetables or other food products and/or food processing equipment or components thereof. The cabinet 1500 includes an outer shell 1501 forming a cavity and disposed within the cavity are a series of inner plates 1502 that define a treatment area 1550 that is not separated from the area 1510 between the inner plates 1502 and the outer shell 1501. One or more of the inner plates 1502 may be configured with one or more openings to accommodate one or more spray nozzles 1503. As described herein in some embodiments openings may be sealed or partially sealed.

In some embodiments, no charge is applied to the food article being treating with a spray, nor is anything done to the food article to ground the food article. In such embodiments, food articles may have inherent charges from the environment through which they passed prior to being treated. For example, residual static electrical charges may be present from processing steps of raw and RTE meats, such as de-feathering poultry, peeling, slicing, etc.

The treatment agents used in any embodiments disclosed herein may be any necessary solution or chemical composition for treating food products, including but not limited to raw and RTE meats, poultry, fish or other seafood, vegetables, fruits, eggs as well as other food products that undergo processing and may benefit from treatment agents, and for treating food processing equipment. Eggs intended for hatching, and other food products that have not matured into the form that they will be immediately prior to processing, may also be treated using the apparatuses and methods disclosed herein.

For example, in a poultry or other meat processing application, antimicrobial agents may be applied via the electrostatic spraying process detailed herein. Any antimicrobial agent capable of being electrostatically charged may be used in the applications detailed herein.

Example embodiments of an antimicrobial agents may include carboxylic acid groups, oxidized carboxylic acids, chlorine-based treatment agents (e.g., chlorine, hypochlorous acid, chlorine dioxide, acidified hypo-chlorite, monochloramine), bromine-based agents (e.g., hypobromous acid), electrolyzed water, trisodium phosphate, acidified sodium sulfate, organic acids (e.g., acetic, citric, lactic), peroxy acetic acid, cetyl pyridinium chloride (CPC), ozonated water and other solutions, sodium lauryl/dodecyl sulfate and other surfactants, lauric arginate, and other sanitizing agents. Treatment agents may include solutions of any of the foregoing agents.

In some embodiments, the treatment agents for use in accordance with one or more of the embodiments of the present invention may also include, but are not limited to, any pathogen inhibitor, bacteriophage, liquid smoke, or other substances list on the United States Department of Agriculture, Food Safety and Inspection Service, current or future version of FSIS Directive 7120.1, Safe and Suitable Ingredients Used in the Production of Meat, Poultry, and Egg Products (Rev. 35, last revised May 24, 2016), or solutions or mixtures of any of the foregoing. In some embodiments one or more of such substances may combined as the treatment agent, such as, e.g. peroxyacetic acid and acetic acid or solutions thereof.

In some embodiments treatment agents may include coatings, glazes, marinades, seasoning, rubs, or other sprayable liquid, particle, powdered coatings, or any solutions or mixtures of any of the foregoing, which may be applied to any number of articles using the systems, apparatus, and methods detailed herein. Additional sprayable liquid or particle coatings may include liquid smoke, smoke fractions, flavor fractions or other food additives or any solutions or mixtures of any of the foregoing.

Treatment agents used in some embodiments may be volatile or hazardous, harmful and/or irritating if allow to escape into the air or environment appurtenant to people or manual laborers. Increasing concentrations of chemicals or antimicrobials in treatment agents, such as, for example, the amount of peroxyacetic acid in a treatment agent that includes peroxyacetic acid may create hazards in the processing plant for meats, fish, vegetables or other food products. One of the advantages of some of the embodiments of the present invention is the ability to safely use higher concentrations of treatment agents or chemicals in treatment agents. Typical ranges of concentration of an acid in a conventional treatment system may be about 500 ppm of the acid to about 1500 ppm depending on the treatment temperature. The embodiments of the present invention may utilize those concentrations and higher concentrations. For example, in the case of a treatment agent that is a solution of peroxyacetic acid, some embodiments of the present invention may utilize solutions of about 1400 parts per million (ppm) to about 4000 ppm of peroxyacetic acid, or more preferably a range of about 2000 ppm to 3000 ppm. In some embodiments, the charging of one or more of the inner plates in a treatment chamber, the charging of one or more of the articles in the treatment chamber, the use of a capture section, the charging of one or more of the inner plates of the capture section, the use of a separator, and/or the use of charging walls or other components of a separator will allow increased concentrations of volatile treatment agents to be electrostatically applied safely.

In some embodiments, one or more spray nozzles may be positioned at distances sufficient to optimize coating of the food article being treated. The appropriate distance between the spray nozzle and the food article being treated may depend on the angle of dispersion of the spray nozzle, air pressure for misting the liquid treatment agent, and the relative charges applied to the inner plates and treatment agent as the greater the charge on the inner plate may focus the intensity of the spray mist of a treatment agent in different directions. For example, in the case of treatment of whole poultry, the distance between the spray nozzle and the poultry may depend on the angle of dispersion of the spray nozzle. In the case of treating poultry with spray nozzles of about 30 degrees to about 45 degrees of dispersion of spray mist, the distance between the spray nozzle and the poultry may be in the range of about 14″ to about 32,″ or more preferably a range of about 22″ to about 26.″ In such an embodiment where whole poultry is being treated, it is preferable to include a spray nozzle directed to disperse treatment agent inside the cavity of the poultry, more preferably the angle of dispersion of the spray nozzle is narrow relative to other spray nozzles used in the treatment system such that the treatment agent is focused into the cavity. In some embodiments, to direct treatment agent into the cavity, one or more inner plates may be used with a charge of the same polarity as the treatment agent, causing the treatment agent to be forced into the cavity of the poultry. This can help maximize the amount of treatment agent (from a spray nozzle that is positioned in a location directed towards a cavity) that enters the cavity of the poultry. In other embodiments depending on the configuration of the treatment chamber, spray nozzles with cones angles of about 60 to about 120 degrees may be used, form example in the embodiment depicted in FIG. 8.

The electrostatic system of some of the embodiments detailed herein may operate through coating a charged article with an oppositely charged agent. For example, with reference to FIG. 1, poultry 10 or another article may be conveyed or disposed within a cabinet 5 and sprayed with a treatment agent. In some embodiments, the poultry 10 or other article may be given a first charge by the charging rod 140 or similar device. The spray assembly 110 may apply a second charge, with the opposite polarity of the first charge, to the antimicrobial agent or other treatment agent. The nozzles 95 may direct the agent onto the articles to be treated, and the treatment agent may then adhere to the articles because of the opposite charges between them. For example, in the embodiment shown in FIGS. 1-7, the poultry 10 may be charged (e.g., with a negative or positive charge) and the oppositely charged antimicrobial agent may be sprayed onto the poultry from the nozzles.

Charging the spray droplets may result in greater attraction of these droplets to the oppositely charged materials, such as the poultry or other articles being treated, thus improving the deposition rate of the antimicrobial agent, the uniformity of deposition of the antimicrobial agent, and may also minimize waste of the antimicrobial agent.

In some embodiments, the charging rods 140, including the finger-like projections or parallel rod, may continue to be charged with a charge of opposite polarity to the treatment agent and may continue to attract the treatment agent spray when not contacting the articles to be treated. In such embodiments, the rod 140 may continue collecting treatment agent, which will prevent cross-contamination (e.g., when using an antimicrobial solution) and sanitize the rod 140 prior to the next poultry carcass or other article to be treated.

While such embodiments greatly reduce the amount of treatment agent required over conventional dipping or spraying methods, treatment agent may still be lost if the agent does not contact or adhere to the poultry or other articles.

The spray may be applied at any desired temperature. In embodiments utilizing an antimicrobial agent, higher temperature may result in greater efficacy, and the antimicrobial agent may be applied at any temperature. For example, in some embodiments, antimicrobial agent or other treatment agent may be applied at about 140° F. In such embodiments, a heater may be provided in or near the cabinet for warming the treatment agent. In other embodiments, the antimicrobial agent may be applied at room temperature. In yet some other embodiments, the antimicrobial agent may be applied during the chilling of the article. Similarly, the articles may be treated at any temperature. For example, the articles may be warmed to increase the efficacy of the treatment agent. In some other embodiments, the articles may be processed at room temperature or in a chilled area.

In some embodiments, the inner plates 80, including end plates 90, may be charged to further improve coverage of the articles being treated while reducing treatment agent consumption. The inner plates 80 may be oriented that a face of the plate (e.g., the flat or curved surface area of the plate) is oriented substantially towards the articles being treated to reflect treatment agent onto the articles. This design may eliminate the loss (attraction) of spray particles to the cabinet walls or shell. For example, in some embodiments, the one or more inner plates 80 may be charged with the same polarity as the treatment agent and the opposite polarity of the articles being treated. In such an embodiment, the treatment agent may be repelled from the inner plates 80 and concentrated onto the articles. In this manner, the inner plates 80 may be disposed behind the articles (e.g., poultry 10) from the nozzles 95 to repel or reflect the spray back towards the articles. The inner plates 80 may further surround all or substantially all of the treatment chamber 50 to concentrate the treatment agent onto the articles being treated. In some embodiments, as shown in FIGS. 1-7, the inner plates 80 may substantially surround the articles being treated except for the cutout openings 92 and other openings (e.g., openings 22, 130) to allow the articles and conveyor system 15 to allow the articles to be processed. In some embodiments, the outer shell 55 and/or the remaining cabinet components may be grounded. In some embodiments, the outer shell 55 and/or remaining components (e.g., the conveyor system 15 or guides 25) may be given the same charge as the spray to further repel the treatment agent.

Because the antimicrobials are charged and misted, any leftover mist can cause environmental hazards to humans working around the treatment system. Unlike traditional sprays, embodiments of the present electrostatic spraying system may spray droplets around 30 microns in diameter, which may hang in the air after spraying. With reference to FIG. 1, one or more capture sections 160 may be disposed on one or more sides of the cabinet 5 to capture any exhausted spray. In the capture sections 160 no charge is added to the poultry 10 or other articles. In some embodiments, the inner plates 80 of the capture sections 160 may be oppositely charged from the treatment agent (e.g., oppositely charged from the inner plates 80 of the treatment cabinet 5) to intentionally capture any charged treatment agent exiting the treatment chamber 50 of the cabinet. This design may capture all of the spray and separate it into the collectors 127, which can then be safely disposed. In addition, the outer shell 55 of the capture sections 160 may also be charged opposite that of the spray. In some embodiments, the outer shell 55 of the capture sections 160 may be grounded. As detailed above, the capture sections 160 may include the same outer shell 55 and inner plate 80 structure found in the cabinet 5. In some embodiments, the capture sections 160 may be repurposed treatment cabinets 5 configured to collect the spray rather than apply it.

In some embodiments, a cyclone separator can be used to capture mist and separate chemicals from air. In some embodiments, the walls or other collection areas of the cyclone separator can be oppositely charged from the spray to enhance separation efficiency. In other embodiments a mesh separator is similarly employed wherein the mesh disposed in a cavity formed by the walls of the mesh separator can be oppositely charged from the spray to enhance separation efficiency.

The systems, apparatus, and methods detailed herein may reduce treatment agent usage by up to approximately 60 times from dip systems without compromising food safety or coverage quality and reduce treatment agent usage by approximately 2 to 3 times when compared to spray systems while providing superior coverage. Because this invention improves the uniformity of treatment, treatment times may also be reduced when compared to conventional spray systems. In embodiments that apply a charge to both the treatment agent and the articles, treatment time may be further reduced and treatment efficacy may be further improved. For example, in some instances an uncharged article may develop the same charge as the treatment agent and may begin repelling further treatment agent; but applying an opposite charge to the article may improve the amount and rate of deposition of the treatment agent.

These systems, apparatus, and methods may be utilized to coat or treat any number of articles. The treatment methods and apparatus described herein may apply treatment agents that include coatings, glazes, marinades, seasoning, rubs, or other sprayable liquid, particle, powdered coatings, or solutions and mixtures of one or more of any of the foregoing. Additional sprayable liquid or particle coatings that may be applied as treatment agents may include liquid smoke, smoke fractions, flavor fractions, other food additives, or solutions and mixtures of one or more thereof.

The embodiments described herein may include sanitizing and decontaminating various articles with sanitizing antimicrobial agents and other sanitizers. In some embodiments food products, such as poultry, may be sanitized using the systems detailed herein. In some other embodiments, reusable equipment, such as food processing equipment, may be treated to sterilize and clean the components of the equipment.

The processing methods may include attaching or connecting the articles (e.g., food products, processing equipment, or other articles) to a conveyor assembly for transporting the articles through the treatment system. In some alternative embodiments, the articles may be placed or stationarily positioned in the treatment system. As the articles contact the charging rod 140, a charge may be applied to the articles. Simultaneously or sequentially with charging the articles, the treatment agent may be charged and sprayed onto the articles within the treatment chamber. In embodiments having a conveyor system, the articles may continuously move through the treatment chamber during processing, or may stop or pause as desired for optimal treatment. The inner plates 80 may reflect or repel and focus the treatment agent onto the articles, and excess agent may be collected by capture sections 160, collectors 127, cyclone separators, and/or other collecting and filtering devices. The coated articles may then be conveyed or removed from the treatment system for further processing, packaging, or use.

The system, apparatus, and methods detailed herein may be applied at multiple processing points in a treatment system. For example, in an antimicrobial embodiment, a treatment cabinet 5 and optional capture sections 160 may be introduced to the processes at any point in which decontamination is needed. For example, in an embodiment configured to treat poultry, the treatment system may be applied before plucking, after plucking, after de-boning, after cutting, before packaging, etc.

In another embodiment, the treatment systems detailed herein can be deployed prior to or during packaging. For instance, when hot dogs and sausages are cooked in casings and/or bags, they are cooled and subsequently, the casing is peeled or the bag is removed prior to packaging. During peeling or subsequent handling of the product, it may be exposed to the processing environment and cross contamination of the product with foodborne pathogens such as Listeria monocytogenes as well as spoilage bacteria can occur. Some alternative embodiments for deploying the treatment systems described herein in the peeling operation of sausages and hot dogs are described above. Uniform application of antimicrobial using the described electrostatic spray system prior to, during or subsequent to peeling and packaging may improve the microbiological safety as well as the shelf life of the food product.

In another embodiment of the present invention, an apparatus for treating articles with treatment agents is provided, the apparatus having a cabinet comprising an outer shell, the outer shell defining a cavity in an interior thereof; a spray assembly disposed within the cabinet, the spray assembly including at least one nozzle, at least one inner plate disposed within the cavity of the outer shell, wherein the at least one inner plate is electrically isolated from the outer shell. The apparatus may further include at least one capture section attached to at least one side of the cabinet. The apparatus may further include at least one capture section including at least a first capture section attached to a first side of the cabinet and a second capture section attached to a second side of the cabinet. The first side of the capture section may be upstream of the cabinet in a treatment process and the second side may be downstream of the cabinet in the treatment process. The apparatus may further include a charged rod attached within the cabinet and disposed at least partially within the cavity of the outer shell.

In another embodiment of the present invention, a method for treating articles with treatment agents is provided. The method comprises disposing an article in the cavity of the outer shell, applying a first charge to a treatment agent, applying a second charge (that is the same polarity as the first charge) to the at least one inner plate, spraying the treatment agent onto the article within the cavity, such that the treatment agent is configured to adhere to the article and is configured to be repelled by the at least one inner plate. The voltages of the first and second charge may be equal or different. The method may further comprise applying a third charge (that is the opposite polarity of the first charge of the treatment agent) to at least one second inner plate of the at least one capture section, and collecting excess treatment agent from the cabinet via at least one capture section attached to at least one side of the cabinet. The method may further comprising reflecting or repelling at least a portion of the treatment agent towards the article with the at least one inner plate. The method may further comprise contacting the article to the charged rod to apply a fourth charge to the article, wherein the first charge applied to the treatment agent has an opposite polarity from the fourth charge. In this method, the disposing of the article in the cavity of the outer shell may comprise transporting the article in the shell via a conveyor, and/or positioning the article in a stationary location within the outer shell.

In another embodiment of the present invention, a method of manufacturing an article treatment apparatus is provided. The method comprising providing a cabinet comprising an outer shell, the outer shell defining a cavity in an interior thereof; disposing a spray assembly within the cabinet, the spray assembly including at least one nozzle configured to deliver a treatment agent having a first charge within the cavity of the cabinet; connecting at least one inner plate within the cavity of the outer shell, such that the at least one inner plate is electrically isolated from the outer shell; wherein the at least one inner plate is configured to be charged with s second charge of the same polarity as the first charge, such that the at least one inner plate is configured to repel the treatment agent having the first charge. The nozzle and inner plate may be configured to apply different amounts of voltages or the same amounts of voltage. The method may further comprise attaching a collector beneath the outer shell of the cabinet, the collector configured to collect excess treatment agent. The method may further comprise connecting a charging rod within the cabinet such that the charging rod is disposed at least partially within the cavity of the outer shell, wherein the charging rod is configured to be charged with a third charge, wherein the third charge may have an opposite polarity from the first charge of the treatment agent, such that the charging rod is configured to apply the third charge to an article to be treated. The method may further comprise comprising attaching at least one capture section to at least one side of the cabinet, wherein the at least one capture section comprises at least one second inner plate configured to receive a fourth charge. The at least one capture section may include at least a first capture section attached to a first side of the cabinet and a second capture section attached to a second side of the cabinet. The first side may be disposed upstream in a treatment process and the second side may be disposed downstream in the treatment process.

In another embodiment of the present invention, an apparatus for treating articles with treatment agents is provided. The apparatus includes a cabinet comprising an outer shell defining a cavity in an interior thereof; a spray assembly disposed within the cabinet, the spray assembly including at least one nozzle configured to deliver a treatment agent having a first charge within the cavity of the cabinet; and at least one inner plate disposed within the cavity of the outer shell, wherein the at least one inner plate is electrically isolated from the outer shell, wherein the at least one inner plate is configured to be charged with the second charge having the same polarity of the first charge, such that the at least one inner plate is configured to repel the treatment agent having the first charge. The spray assembly and at least one inner plate may be configured to apply amount of voltages of the first and second charge that are equal or different. The at least one inner plate of the apparatus may comprise at least two inner plates defining a treatment chamber there-between, and defining an outer cavity between at least one of the at least two inner plates and the outer shell of the cabinet. The apparatus may also include a charging rod attached within the cabinet and disposed at least partially within the cavity of the outer shell, wherein the charging rod is configured to be charged with a third charge, wherein the third charge has an opposite polarity from the first charge of the treatment agent, such that the charging rod is configured to apply the third charge to an article so that the article attracts the treatment agent having an opposite first charge. The apparatus may also include an insulating member disposed between the outer shell and the at least one inner plate, wherein the insulating member is configured to electrically isolate the at least one inner plate from the outer shell. The outer shell may be a plurality of wall segments. The apparatus may also include a collector attached beneath the outer shell of the cabinet, the collector configured to collect excess treatment agent. The apparatus may further include at least one capture section attached to at least one side of the cabinet, wherein the at least one capture section comprises at least one second inner plate configured to receive a fourth charge of opposite polarity to the first charge of the treatment agent. The at least one capture section may include at least a first capture section attached to a first side of the cabinet and a second capture section attached to a second side of the cabinet. The first side may be disposed upstream in a treatment process and the second side may be disposed downstream in the treatment process. The apparatus may also include a conveyor connected to the cabinet for transporting an article in the outer shell of the cabinet. The at least one inner plate of the apparatus may comprise at least two inner plates defining a treatment chamber there-between and include a conveyor connected to the cabinet for transporting into and/or through the treatment chamber.

In some embodiments the outer shell of the cabinet (or one or more portions of the outer shell) will be integral with the inner plate. In some embodiments the outer shell (or one or more portions of it) may be the inner plate whereby the inner wall of the outer shell (or one or more portions thereof) that is adjacent to the treatment chamber functions as the inner plate. In such an embodiments where the outer shell of the cabinet is the same or integrated with the inner plate, there will be no electrical isolation between the outer shell and the inner plate and thus when the inner plate is charged, the outer shell will also be charged. The outer shell may therefore be insulated or coated on its exterior with an insulating material to protect the charge of the inner plate to make contact with things and people outside the cabinet. Some embodiments will not require such an insulating or coating to protect the charge of the inner plate from making contact with things and people.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. It will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, and with other elements, materials, and components, without departing from the spirit or essential characteristics thereof. One skilled in the art will appreciate that the invention may be used with many modifications of structure, arrangement, proportions, materials, and components and otherwise, used in the practice of the invention, which are particularly adapted to specific environments and operative requirements without departing from the principles of the present invention. Although specific terms are employed herein, they are used in a generic and descriptive sense only and not for purposes of limitation. In addition, features described herein may be used singularly or in combination with other features. It is understood, therefore, that this invention is not limited to the particular embodiments disclosed, but it is intended to cover modifications within the spirit and scope of the present invention as described in the appended claims. Moreover, the lack of the word “means” in the claims is consistent with Applicant's intention not to use the means-plus-function claiming format.

1. A method for treating a food article comprising:
disposing a food article in a cavity within an enclosure having an outer shell and at least one inner plate disposed in the cavity;
applying a first charge to a treatment agent;
applying a second charge to the at least one inner plate of the same polarity as the first charge;
spraying the treatment agent into the cavity in a manner whereby at least a portion of the treatment agent is caused to be repelled by the at least one inner plate and to at least partially coat the food article.

2. The method of claim 1, further comprising contacting the food article to at least one charged body to apply a third charge to the food article, wherein the third charge has an opposite polarity to the second charge.

3. The method of claim 2, wherein the at least one charged body is one or more of the following: a rod, pin, brush, bristle and wire.

4. The method of claim 1, further comprising collecting a portion of treatment agent that did not at least partially coat the food article in a capture section having a capture cavity that is attached to the enclosure.

5. The method of claim 4, further comprising applying a charge of opposite polarity to the first charge to at least one second inner plate that is disposed in the capture cavity.

6. The method of claim 4, wherein the collecting of a portion of treatment agent occurs on a first side of the enclosure and a second side of the enclosure.

7. The method of claim 4, wherein the collected portion of treatment agent passes through a separator including at least one conductive component that is charged with a charge of opposite polarity to the treatment agent thereby attracting the treatment agent.

8. The method of claim 1, wherein disposing a food article in a cavity within an enclosure having an outer shell comprises transporting the food article via a conveyor.

9. The method of claim 8, wherein the conveyor is one or more of the following: a conveyor belt, a cabling system, and shelves.

10. The method of claim 1, wherein applying a first charge to a treatment agent is applied by a spray nozzle connected to a charging element.

11. The method of claim 1, wherein spraying the treatment agent is sprayed through one or more spray nozzles.

12. The method of claim 1, wherein spraying the treatment agent is sprayed between the at least one inner plate and the food article.

13. The method of claim 1, wherein the food article is one or more of the following: raw meat, raw poultry, raw meat parts, raw poultry parts, ready-to-eat (“RTE”) meat, RTE poultry, eggs, vegetables, and fruits.

14. The method of claim 1, wherein the outer shell and at least one inner plate are integrated as one component of the enclosure and wherein the at least one inner plate forms part of the cavity.

15. The method of claim 1, wherein the treatment agent contains an agent that inhibits the growth of foodborne pathogens or microorganisms.

16. The method of claim 1, wherein the treatment agent is an antimicrobial agent.

17. The method of claim 16, wherein the antimicrobial agent includes one or more of the following: carboxylic acids, oxidized carboxylic acids, chlorine, hypochlorous acid, chlorine dioxide, acidified hypo-chlorite, monochloramine, bromine, hypobromous acid, electrolyzed water, trisodium phosphate, acidified sodium sulfate, acetic acid, citric acid, lactic acid, peroxyacetic acid, and cetyl pyridinium chloride (CPC).

18. The method of claim 1, further comprising separating a portion of the treatment agent that did not at least partially coat the food article after the spraying of the treatment agent in a separator wherein at least one component of the separator is charged with a charge of opposite polarity to the first charge of the treatment agent whereby the treatment agent is caused to be attracted to the at least one component of the separator and separated from the air inside the enclosure.

19. An apparatus for treating food articles and food processing articles, comprising:
an enclosure comprising an outer shell defining a cavity in an interior thereof;
a spray assembly disposed within the cabinet, the spray assembly including at least one spray nozzle configured to deliver a treatment agent having a first charge within the cavity of the cabinet; and
at least one inner plate disposed within the cavity of the outer shell, wherein the at least one inner plate is electrically isolated from the outer shell,
wherein the at least one inner plate is configured to be charged with a second charge of the same polarity as the first charge.

20. The apparatus of claim 19, wherein within the cavity defined by the outer shell of the enclosure, the at least one inner plate defining a second inner cavity that is a treatment chamber.

21. The apparatus of claim 19, further comprising at least one charging body configured to apply a third charge to a food article or food processing article, wherein the third charge has an opposite polarity from the second charge.

22. The apparatus of claim 21, wherein the at least one charging body is one or more of the following: a rod, pin, brush, bristle and wire.

23. The apparatus of claim 19, further comprising at least one capture section that is attached to the enclosure and configured to collect treatment agent, the at least one capture section comprising a second enclosure comprising a second outer shell defining a capture cavity in an interior thereof.

24. The apparatus of claim 23, further comprising at least one second inner plate that is disposed in the capture cavity, wherein the at least one second inner plate is electrically isolated from the second outer shell that defines the capture cavity and configured to be charged with a charge of opposite polarity to the first charge.

25. The apparatus of claim 23, wherein at least one capture section is attached to a first side of the enclosure, and at least one capture section is attached to a second side of the enclosure.

26. The apparatus of claim 19, further comprising a conveyor for transporting a food article into the cavity of the outer shell.

27. The apparatus of claim 26, wherein the conveyor is one or more of the following: a conveyor belt, a cabling system, and shelves.

28. The apparatus of claim 19, wherein the enclosure is cylindrically shaped.

29. The apparatus of claim 19, wherein the enclosure is half cylindrically shaped.

30. The apparatus of claim 19, wherein the at least one inner plate is cylindrically shaped.

31. The apparatus of claim 19, wherein the at least one inner plate is curved.

32. The apparatus of claim 19, wherein the at least one inner plate is a plurality of inner plate segments.

33. The apparatus of claim 19, wherein the outer shell is one or more wall segments.

34. The apparatus of claim 19, wherein the at least one spray nozzle is a coned shaped nozzle.

35. The apparatus of claim 19, further comprising a separator compromising an enclosure defining a separating cavity where the enclosure is formed by at least one wall, wherein the at least one wall is configured to be charged with a charge of opposite polarity to the first charge to attract the treatment agent.

36. The apparatus of claim 19, further comprising a separator compromising an enclosure defining a separating cavity with at least one mesh screen disposed in the separating cavity, wherein the mesh screen is configured to be charged with a charge of opposite polarity to the first charge to attract the treatment agent.

37. A method for spraying a food processing article with a treatment agent comprising
disposing a food processing article in a cavity within an enclosure having an outer shell and at least one inner plate disposed in the cavity;
applying a first charge to a treatment agent;
applying a second charge to the at least one inner plate of the same polarity as the first charge;
spraying the treatment agent into the cavity in a manner whereby at least a portion of the treatment agent is caused to be repelled by the at least one inner plate and to at least partially coat the food processing article.

38. The method of claim 37, further comprising contacting the food processing article to at least one charged body to apply a third charge to the food article, wherein the third charge has an opposite polarity to the second charge.

39. The method of claim 37, further comprising collecting a portion of treatment agent that did not at least partially coat the food processing article in a capture section having a capture cavity that is attached to the enclosure.

40. The method of claim 39, further comprising applying a charge of opposite polarity to the first charge to at least one second inner plate that is disposed in the capture cavity.

41. The method of claim 37, wherein disposing a food processing article in a cavity within an enclosure having an outer shell comprises transporting the food article via a conveyor.

42. The method of claim 37, wherein the applying a first charge to a treatment agent is applied by one or more spray nozzles connected to a charging element.

43. The method of claim 37, wherein the food processing article is one or more of the following: a slicer, peeler, and cutting tool.

44. The method of claim 37, wherein the food processing article is a component of a peeler.

45. The method of claim 37, wherein the outer shell and at least one inner plate are integrated as one component of the enclosure and wherein the at least one inner plate forms part of the cavity.

46. The method of claim 37, wherein the treatment agent is an antimicrobial agent.

47. The method of claim 37, further comprising separating a portion of the treatment agent that did not at least partially coat the food processing article after the spraying of the treatment agent in a separator wherein at least one component of the separator is charged with a charge of opposite polarity to the first charge of the treatment agent whereby the treatment agent is caused to be attracted to the at least one component of the separator and separated from the air inside the enclosure.
